(19) United States
(12) Patent Application Publication
(10) Pub. No.: US 2026/0147759 A1
(43) Pub. Date: May 28, 2026

(54) METHOD OF USING LARGE LANGUAGE MODEL, ELECTRONIC DEVICE INCLUDING LARGE LANGUAGE MODEL, AND LARGE LANGUAGE MODEL-BASED SYSTEM

(71) Applicant: SAMSUNG ELECTRONICS CO., LTD., Suwon-si (KR)

(72) Inventor: Jonghyun KIM, Suwon-si (KR)

(73) Assignee: SAMSUNG ELECTRONICS CO., LTD., Suwon-si (KR)

(21) Appl. No.: 19/404,840

(22) Filed: Dec. 1, 2025

Related U.S. Application Data
(63) Continuation of application No. PCT/KR2025/019293, filed on Nov. 20, 2025.

(30) Foreign Application Priority Data
Nov. 27, 2024 (KR) 10-2024-0172777
Feb. 18, 2025 (KR) 10-2025-0020963

(51) Int. Cl. G06F 16/2453

(52) U.S. Cl. CPC G06F 16/24542

(57) ABSTRACT

A method may include: obtaining an input query; generating, by using a large language model (LLM), based on the input query, a plan query comprising one or more blank queries related to a first sub-module and one or more operations to be performed by the first sub-module; transmitting, to the first sub-module, (a) a request for generating a first response comprising one or more values corresponding to the one or more blank queries, (b) at least a part of the plan query, and (c) a first guide query, the first guide query being based on a part of the input query associated with the first sub-module; receiving, from the first sub-module, the first response generated by using a sub-language model (LM) of the first sub-module; and generating, by using the LLM, a final response to the input query, based on the first response.

### CROSS-REFERENCES TO RELATED APPLICATIONS

This application is a bypass continuation of International Application No. PCT/KR2025/019293, filed on Nov. 20, 2025, with the Korean Intellectual Property Office, which claims priority to Korean Patent Application No. 10-2024-0172777, filed on Nov. 27, 2024, and Korean Patent Application No. 10-2025-0020963, filed on Feb. 18, 2025, the disclosures of which are incorporated by reference herein in their entireties.

### BACKGROUND

### 1. Field

The disclosure relates to a method of processing a user query by using an artificial intelligence (AI) model, and more particularly, to a method of using a large language model (LLM), an electronic device including the LLM, and an LLM-based system.

### 2. Description of Related Art

Recently, with the development of artificial intelligence (AI) technology, the field of natural language processing (NLP) is rapidly developing. In particular, large language models (LLM) are being highlighted as a technology capable of performing text generation, translation, summarization, answering questions, or the like at a level similar to that of humans. A language model enables natural interactions with humans and provides real values in the field of various industries such as healthcare, finance, education, or the like. For example, an LLM is capable of analyzing a user request and dynamically calling an appropriate function or connecting to an external system so as to perform tasks. Accordingly, an LLM may contribute to improving efficiency and user experience in various services such as virtual assistants, smart home control, or the like.

### SUMMARY

According to an embodiment of the disclosure, a method may include obtaining an input query. The method may include generating, by using a large language model (LLM), based on the input query, a plan query comprising one or more blank queries related to a first sub-module and one or more operations to be performed by the first sub-module, the first sub-module comprising a sub-language model (LM). The method may include transmitting, to the first sub-module, (a) a request for generating a first response comprising one or more values corresponding to the one or more blank queries, (b) at least a part of the plan query, and (c) a first guide query, the first guide query being based on a part of the input query associated with the first sub-module. The method may include receiving, from the first sub-module, the first response generated by using the sub-LM of the first sub-module, the first response comprising the one or more values. The method may include generating, by using the LLM, a final response to the input query, based on the first response.

According to an embodiment of the disclosure, a non-transitory computer-readable storage medium storing instructions may be provided. The instructions when executed by at least one processor, collectively or individually, may cause the at least one processor to obtain an input query. The instructions when executed by at least one processor, collectively or individually, may cause the at least one processor to generate, by using a large language model (LLM), based on the input query, a plan query comprising one or more blank queries related to a first sub-module and one or more operations to be performed by the first sub-module, the first sub-module comprising a sub-language model (LM). The instructions when executed by at least one processor, collectively or individually, may cause the at least one processor to transmit, to the first sub-module, (a) a request for generating a first response comprising one or more values corresponding to the one or more blank queries, (b) at least a part of the plan query, and (c) a first guide query, the first guide query being based on a part of the input query associated with the first sub-module. The instructions when executed by at least one processor, collectively or individually, may cause the at least one processor to receive, from the first sub-module, the first response generated by using the sub-LM of the first sub-module, the first response comprising the one or more values. The instructions when executed by at least one processor, collectively or individually, may cause the at least one processor to generate, by using the LLM, a final response to the input query, based on the first response.

According to an embodiment of the disclosure, an electronic device may be provided. The electronic device may include at least one processor comprising processing circuitry; and memory comprising one or more storage media and storing one or more instructions. The one or more instructions, when executed by the at least one processor individually or collectively, may cause the electronic device to obtain an input query. The instructions when executed by at least one processor, collectively or individually, may cause the at least one processor to generate, by using a large language model (LLM), based on the input query, a plan query comprising one or more blank queries related to a first sub-module and one or more operations to be performed by the first sub-module, the first sub-module comprising a sub-language model (LM). The instructions when executed by at least one processor, collectively or individually, may cause the at least one processor to transmit, to the first sub-module, (a) a request for generating a first response comprising one or more values corresponding to the one or more blank queries, (b) at least a part of the plan query, and (c) a first guide query, the first guide query being based on a part of the input query associated with the first sub-module. The instructions when executed by at least one processor, collectively or individually, may cause the at least one processor to receive, from the first sub-module, the first response generated by using the sub-LM of the first sub-module, the first response comprising the one or more values. The instructions when executed by at least one processor, collectively or individually, may cause the at least one processor to generate, by using the LLM, a final response to the input query, based on the first response.

According to an embodiment of the disclosure, a system may be provided. The an electronic device storing a large language model (LLM), and a first external electronic device configured to communicate with the electronic device and comprising a first sub-module. The electronic device may be configured to obtain an input query; generate, by using the LLM, based on the input query, a plan query comprising one or more blank queries related to the first sub-module, the first sub-module comprising a first sub-language model (LM), and one or more first operations to be performed by the first sub-module; transmit, to the first sub-module, (a) a request for generating a first response comprising one or more values corresponding to the one or more blank queries, (b) at least a part of the plan query, and (c) a first guide query at least partly based on a part of the input query which is related to the first sub-module; receive, from the first sub-module, the first response generated by using the first sub-LM and comprising the one or more values; generate, by using the LLM, a final response to the input query, based on the first response.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an example of a large language model (LLM)-based system, according to an embodiment of the disclosure;

FIG. 2 is a block diagram of an example of an electronic device according to an embodiment of the disclosure;

FIG. 3 is a flowchart of a method according to an embodiment of the disclosure;

FIG. 4 is a flowchart of an example of an operation of generating a plan query, according to an embodiment of the disclosure;

FIG. 5 illustrates an example of an operation for generating a plan query, according to an embodiment of the disclosure;

FIG. 6 is a flowchart of an example of a method of generating a plan query, according to an embodiment of the disclosure;

FIG. 7 is a block diagram of an example of an agnostic checker, according to an embodiment of the disclosure;

FIG. 8 illustrates an example of an operation for modifying an expectation function, according to an embodiment of the disclosure;

FIG. 9 illustrates an example of an operation for at least partly filling a plan query according to an embodiment of the disclosure;

FIG. 10 is a flowchart of an example process for generating a final response, according to an embodiment of the disclosure;

FIG. 11 is a flowchart of an example process for generating a final response, according to an embodiment of the disclosure;

FIG. 12 is a flowchart of an example process for generating a final response by using a subsequent plan query according to an embodiment of the disclosure;

FIG. 13 is a block diagram of an example of a sub-module according to an embodiment of the disclosure;

FIG. 14 is a flowchart of an example process for generating a response by using a sub-language model (LM), according to an embodiment of the disclosure;

FIG. 15 illustrates an example of operations for generating a response by using a sub-LM, according to an embodiment of the disclosure; and

FIG. 16 is a block diagram of an example of an LLM-based system according to an embodiment of the disclosure.

### DETAILED DESCRIPTION

Although the terms used in embodiments of the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

The terms used in the disclosure are just for the purpose of describing particular embodiments of the disclosure and are not intended to limit the scope of other embodiment of disclosure. As used herein, the singular forms “a,” “an,” and “the” may include the plural forms as well, unless the context clearly indicates otherwise. All the terms used in the present specification, including technical and scientific terms, may have the same meanings as those generally understood by one of skill in the art of the disclosure. The terms of the disclosure which are defined in commonly used dictionaries may be interpreted as having the same meanings as the contextual meanings of the related art and will not be interpreted in an idealized or overly formal sense unless expressly so defined herein. In some cases, even the terms defined in the disclosure may not be interpreted to exclude the embodiments of the disclosure.

As used herein, the singular forms “a,” “an,” and “the” may include the plural forms as well, unless the context clearly indicates otherwise. All the terms used in the present specification, including technical and scientific terms, may have the same meanings as those generally understood by one of skill in the art of the disclosure.

Also, in the disclosure, when a part “includes” or “comprises” an element, unless there is a particular description contrary thereto, the part can further include other elements, not excluding the other elements. Also, the terms such as “ . . . unit,” “module,” or the like used in the disclosure indicate a unit, which processes at least one function or operation, and the unit may be implemented by hardware or software, or by a combination of hardware and software.

The expression “configured to (or set to)” used in the disclosure may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured to (or set to) perform A, B, and C” may refer to a dedicated processor (e.g., an embedded processor) for performing a corresponding operation, or a general-purpose processor (e.g., a central processing unit (CPU) or an application processor (AP)) capable of performing a corresponding operation by executing one or more software programs stored in memory.

Also, in the disclosure, it should be understood that when elements are “connected” or “coupled” to each other, the elements may be directly connected or coupled to each other, but may alternatively be connected or coupled to each other with an element therebetween, unless specified otherwise.

In the disclosure, expressions such as ‘greater than’ or ‘less than’ may be used to determine whether particular conditions are satisfied or fulfilled; however, these are merely examples, and do not exclude descriptions using ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’.

Hereinafter, a hardware-based method will be described as an example in various embodiments of the disclosure. However, as various embodiments of the disclosure include a technology for using all of hardware and software, various embodiments of the disclosure do not exclude a software-based method.

In some embodiments of the disclosure, an artificial intelligence (AI) model may refer to a model including a plurality of neural network layers. Each of the neural network layers may include a plurality of weight values. Each neural network layer may perform a neural network operation through an operation between an operation result of a previous layer and the plurality of weight values. The plurality of weight values of the plurality of neural network layers may be optimized due to a training result of the AI model. For example, the plurality of weight values may be updated to reduce or minimize a loss value or a cost value obtained by the AI model during a training process. Examples of the AI neural network may include a deep neural network (DNN). For example, the AI model may be based on one or more of various neural networks including a convolutional neural network (CNN), a recurrent neural network (RNN), a restricted Boltzmann machine (RBM), a deep belief network (DBN), a bidirectional recurrent deep neural network (BRDNN), a Deep Q-Network (DQN), or the like, but the disclosure is not limited thereto.

In the disclosure, a function related to an AI operates via a processor and memory. The processor may include one or more processors. In this regard, the one or more processors may each be a general-purpose processor, a graphics-dedicated processor, or an AI-dedicated processor. The one or more processors may process input data, according to predefined operating rules or an AI model stored in the memory. In an embodiment of the disclosure, when the one or more processors are each an AI-dedicated processor, the AI-dedicated processor may be designed in a hardware structure specialized for processing a particular AI model.

The predefined operating rules or the AI model may be generated via a training process. Here, being generated via a training process may mean that the predefined operation rules or the AI model set to perform desired characteristics (or purposes), is generated by training an AI model by using a learning algorithm that utilizes a large amount of training data. Such training may be performed by a device on which AI according to the disclosure is implemented or by a separate server and/or a system. Examples of the learning algorithm may include supervised learning, unsupervised learning, semi-supervised learning, or reinforcement learning, but the disclosure is not limited to the example above.

According to some embodiments of the disclosure, a language model (LM) or a large language model (LLM) may refer to an AI model designed for natural language processing (NLP) such as understanding of language or generation of language. For example, the LM may be understood as an AI model trained to generate a natural language-format output, in response to input data. For example, the AI model may be trained to generate and output natural language-format description of an input image. In an embodiment of the disclosure, the LM may be a monomodal/unimodal model trained to process a single-format input (e.g., a text input, an image input, or an audio input). In an embodiment of the disclosure, the LM may be a multimodal model trained to process inputs of a plurality of formats.

In some embodiments of the disclosure, the term “sub-module” may refer to a module configured to perform a set of features supported by any one of one or more hardware devices (e.g., electronic devices, apparatuses, or home appliances), or a plurality of items of software (e.g., application or computer-readable program). One sub-module may be configured for each hardware or software function. Hardware or software may correspond to one or more sub-modules. For example, when the number of features supported by one device exceeds a threshold number, a plurality of sub-modules may be configured for one device, the features may be distributed between the plurality of sub-modules, and each sub-module may handle a set of separate features that do not overlap. In some embodiments of the disclosure, the term ‘domain’ may indicate a set of sub-modules. In some embodiments of the disclosure, the terms ‘sub-module’ and ‘module’ may be used interchangably.

As used herein, the term “query” may refer to a data input to an LLM or a data output from an LLM. The query may be generated by a user or an external system and be provided to the LLM, comprising a specific instruction or request for a task. The query may be generated by the LLM as a structured data and be transmitted to an external database, an application programming interface (API), an external language model, or other systems to request information for performing a task. The query may function as an communication medium for a LLM-based system, conveying user requests and acquiring corresponding information.

Hereinafter, an embodiment of the disclosure will be described in detail with reference to the accompanying drawings to allow one of skill in the art to easily implement the embodiment. The disclosure may, however, be embodied in many different forms and should not be construed as being limited to an embodiment set forth herein.

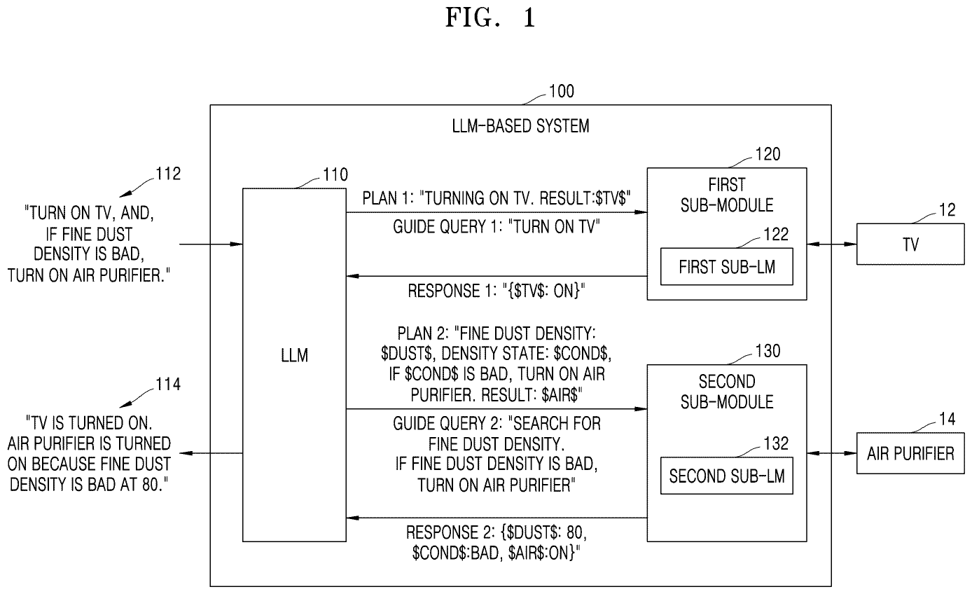

FIG. 1 is a block diagram of an example of an LLM-based system 100, according to an embodiment of the disclosure.

Referring to FIG. 1, the LLM-based system 100 may include an LLM 110, a first sub-module 120, and a second sub-module 130. The first sub-module 120 may include a first sub-LM 122. The second sub-module 130 may include a second sub-LM 132. The first sub-module 120 may manage features supported by a television (TV) 12. The second sub-module 130 may manage features supported by an air purifier 14.

The LLM-based system 100 may generate a final response 114 to an input query 112 by using the first sub-LM 122 and the second sub-LM 132. In response to the input query 112, the LLM-based system 100 may control, by using the LLM 110, the first sub-LM 122, and the second sub-LM 132, various electronic devices, entities, apparatuses, and/or home appliances including the TV 12, the air purifier 14, or the like. The LLM-based system 100 may control the TV 12 and/or the air purifier 14 to perform one or more operations indicated by the input query 112. Based on a result of performing the one or more operations, the LLM-based system 100 may generate the final response 114 by using the LLM 110, the first sub-LM 122, and the second sub-LM 132.

In order to achieve a goal indicated by the input query 112, the LLM-based system 100 may establish a plan including a flow of operations, steps, or tasks, by using the LLM 110. Based on the plan established using the LLM 110, the LLM-based system 100 may control one or more devices (e.g., the TV 12 and the air purifier 14) connected to the LLM-based system 100, by using the first sub-LM 122 and the second sub-LM 132. The first sub-LM 122 and the second sub-LM 132 may provide the LLM 110 with a response indicating an operation performance result of a corresponding device, based on the plan established by the LLM 110. The LLM 110 may generate the final response 114 based on a response respectively from sub-LMs.

The LLM-based system 100 may control, by using the LLM 110, the first sub-LM 122, and the second sub-LM 132, the TV 12 and the air purifier 14 so as to achieve the goal indicated by the input query 112. The LLM 110 may perform planning and reasoning. For example, the LLM 110 may analyze the input query 112, may establish a plan for achieving a goal of the input query 112, may process responses from the first sub-module 120 and the second sub-module 130, and may generate a final response. The first sub-LM 122 and the second sub-LM 132 may be used to perform detailed operations of each module. For example, the first sub-LM 122 and the second sub-LM 132 may rewrite an augmented query for each sub-module, may retrieve or search for a function to be executed by a corresponding electronic device, and may generate a response for returning values obtained according to execution of the function.

The LLM 110 may establish a general plan based on the input query 112, and may generate a final response based on a response respectively obtained from sub-modules. The LLM 110 may modify (or, distribute or transform) a plan and/or the input query 112 for each performing entity. The LLM 110 may transmit a return request for particular value(s), along with the modified plan and/or the modified input query, to a sub-module corresponding to each performing entity. The LLM 110 may collect a response from each sub-module. Based on the response from each sub-module, the LLM 110 may establish an additional plan, may generate an additional query, and/or may establish a final response.

According to an embodiment of the disclosure, the LLM 110 may be trained to decompose the input query 112 into parts related to each sub-module. The LLM 110 may be trained to determine, based on decomposed queries, one or more operations indicated by the input query 112, each performing entity of each operation, and an order of the one or more operations. For example, the LLM 110 may decompose the input query 112, and may determine which sub-module is to perform which operation(s) from among the one or more operations indicated by the input query 112. Based on the determined one or more operations, the determined each performing entity of each operation, and the determined order of the one or more operations, the LLM 110 may generate a blank plan.

The blank plan may include a sequence of one or more steps, one or more operations, or one or more tasks for achieving a goal indicated by the input query 112. According to an embodiment of the disclosure, the blank plan may be also referred to as a query or a plan query. According to an embodiment of the disclosure, the a sequence of one or more steps, one or more operations, or one or more tasks included in the plan query may be referred to as a sub-query, an operation query, or a task query. The plan query may include one or more blank fields. Each blank field may be a field for indicating that an element or a parameter corresponding to the field currently corresponds to a blank value (or an empty value). According to an embodiment of the disclosure, the blank field may also be referred to as a sub-query, or a blank query. According to an embodiment of the disclosure, a blank query may correspond to a query for a value corresponding to a blank field. The LLM 110 may determine an element (or parameter) for which an actual value is required to achieve the goal of the input query 112 or an element for which a subsequent plan (e.g., a subsequent operation or a subsequent scenario) may be changed according to a state or an attribute of a performing entity. The LLM 110 may determine the determined element as the blank field. In an embodiment of the disclosure, the LLM 110 may designate an empty character string or a null value to the blank field, or may temporarily insert dummy values thereto.

According to an embodiment of the disclosure, in the plan query, the blank field may be marked, based on a predefined rule. For example, the LLM 110 may indicate that a particular field in the plan query is a blank field or a blank query, by using a symbol ‘$’, but an embodiment of the disclosure are not limited thereto.

According to an embodiment of the disclosure, the blank field may correspond to at least one of an actual value to be obtained from a sub-module, a value dependent on a state of the sub-module, a value dependent on an attribute of the sub-module, a value indicating a result of an operation performed by the sub-module, or a condition indicated by an input query.

For example, in the embodiment shown in FIG. 1, the input query 112 may be “Turn on TV, and, if fine dust density is bad, turn on air purifier.”. The LLM 110 may analyze the input query 112. The LLM 110 may identify a goal (e.g., turning on TV and, turning on air purifier if fine dust density is bad) indicated by the input query 112. The LLM 110 may determine one or more operations (e.g., turning on TV, searching for fine dust density, and turning on air purifier if fine dust density is bad) for achieving the goal and a performing entity (e.g., any one of the first sub-module 120 related to the TV 12 and the second sub-module 130 related to the air purifier 14) of each operation. The LLM 110 may determine one or more elements to be designated as a blank field or a blank query. For example, the LLM 110 may designate, as blank queries (e.g., first blank query, second blank query, etc.), a result of an operation of turning on TV, a result of searching for fine dust density (e.g., a value of fine dust density), a case where fine dust density is bad which is a precedent condition for an operation of turning on air purifier, and a result of the operation of turning on air purifier. In the plan query, the LLM 110 may represent a blank query corresponding to the result of an operation of turning on TV as ‘$TV$’. The LLM 110 may represent, in the plan query, a blank query corresponding to the result of searching for fine dust density as ‘$DUST$’. The LLM 110 may represent, in the plan query, a blank query corresponding to the condition of the case where fine dust density is bad as ‘$COND$’. The LLM 110 may represent, in the plan query, a blank query corresponding to the result of turning on air purifier as ‘$AIR$’. The LLM 110 may output the plan query including the aforementioned blank fields of ‘$TV$’, ‘$DUST$’, ‘$COND$’, and ‘$AIR$’. For example, the plan query output by the LLM 110 may be as ‘Turning on TV. Result: $TV$. Fine dust density: $DUST$, Density state: $COND$, If $COND$ is bad, turn on air purifier. Result: $AIR$.’
The LLM 110 may provide at least a part of the plan query to each sub-module. The LLM 110 may decompose the plan query to parts related to respective sub-modules, and may provide a part of the decomposed plan query to a corresponding sub-module. For example, the LLM 110 may provide, to the first sub-module 120, a part (e.g., ‘Plan 1: “Turning on TV. Result: $TV$”’) of the plan query, the part including operations to be performed by the first sub-module 120. The LLM 110 may provide, to the second sub-module 130, a part (e.g., ‘Plan 2: “Fine dust density: $DUST$, Density state: $COND$, If $COND$ is bad, turn on air purifier. Result: $AIR$”’) of the plan query, the part including operations to be performed by the second sub-module 130. The LLM 110 may provide all parts of the plan query to each sub-module.

The LLM 110 may transmit a corresponding guide query to each sub-module. The guide query may be generated based on a part of the input query 112, the part being related to a corresponding sub-module. The LLM 110 may sort parts of the input query 112 which are related to respective sub-modules as guide queries for the respective sub-modules. Based on a guide query, each sub-module may focus on operation to be performed by each sub-module.

For example, the LLM 110 may decompose the input query 112 into ‘Turn on TV’ and ‘If fine dust density is bad, turn on air purifier’. The LLM 110 may identify ‘Turn on TV’ as a part of the decomposed queries, the part being related to the first sub-module 120 related to the TV 12. Based on ‘Turn on TV’, the LLM 110 may output a guide query (e.g., ‘Guide query 1: “Turn on TV”’) for the first sub-module 120. The LLM 110 may identify ‘If fine dust density is bad, turn on air purifier’ as a part of the decomposed queries, the part being related to the second sub-module 130 related to the air purifier 14. Based on “If fine dust density is bad, turn on air purifier”, the LLM 110 may generate a guide query (e.g., ‘Guide query 2: “Search for fine dust density. If fine dust density is bad, turn on air purifier”’) for the second sub-module 130.

The LLM 110 may transmit a corresponding guide query and at least a part of the plan query to each sub-module, and may concurrently ask each sub-module to return a value of filling at least one blank field or blank query included in the plan query. According to an embodiment, the LLM 110 may transmit, to each sub-module, a request for generating a response comprising one or more values corresponding to one or more blank queries included in the plan query. For example, the LLM 110 may request the first sub-module 120 to return a value for filling the blank field or blank query ‘$TV$’ related to the first sub-module 120. The LLM 110 may request the second sub-module 130 to return values for filling the blank queries ‘$DUST$’, ‘$COND$’, and ‘$AIR$’ related to the second sub-module 130. A request for returning a value for filling a blank field or blank query may be understood as a request for filling the blank field, or a request for generating a response comprising an actual value corresponding to the blank field or the blank query. A value for filling a blank field or a blank query may be understood as an actual value corresponding to the blank field or the blank query. Filling a blank field or a blank query may be understood as obtaining an actual value which corresponds (or fits) to the blank field or the blank query. Additionally or alternatively, filling the blank field or the blank query may comprise replacing or substituting dummy value of the blank field or the blank query with the actual value.

The first sub-module 120 may perform one or more operations for filling the blank field or the blank query ‘$TV$’, based on ‘Plan 1’ and ‘Guide query 1’, by using the first sub-LM 122. For example, the first sub-module 120 may perform one or more operations for turning on the TV 12, and may fill the blank field ‘$TV$’, based on a result of performing the operations, by using the first sub-LM 122. The second sub-module 130 may perform one or more operations for filling the blank query s ‘$DUST$’, ‘$COND$’, and ‘$AIR$’, based on ‘Plan 2’ and ‘Guide query 2’, by using the second sub-LM 132. For example, the second sub-module 130 may perform one or more operations for controlling power of the air purifier 14 according to fine dust density, and may fill the blank queries ‘$DUST$’, ‘$COND$’, and ‘$AIR$’, based on a result of performing the operations, by using the second sub-LM 132.

According to an embodiment of the disclosure, each sub-module 120/130 may include sub-LM 122/132. A sub-LM may be an LM specified for a sub-module and/or a device to be controlled by the sub-module. For example, the sub-LM may be trained and/or continually updated according to a current specification of the device to be controlled by the sub-module. The sub-LM may rewrite a query given from the LLM 110 to a query specified for the sub-module so that the query may conform to the current specification of the device to be controlled by the sub-module. By using the rewritten query, the sub-LM may generate a command, an instruction, or code for retrieving a function to be executed in a corresponding sub-module for the sub-module to perform an appropriate operation, based on a modified plan and/or input query provided from the LLM 110. The sub-LM may generate a command, an instruction, or code for controlling a device, equipment, or a home appliance to execute the retrieved function. Based on operation(s) of the device, the equipment, or the home appliance, the sub-LM may generate a response including value(s) to be returned to the LLM 110.

For example, the first sub-LM 122 may identify that the first sub-module 120 has to perform an operation of turning on TV and return a value corresponding to the blank field ‘$TV$’ to the LLM 110, based on ‘Plan 1’ and ‘Guide query 1’. The first sub-LM 122 may rewrite ‘Guide query 1’ by considering the current specification of the first sub-module 120. Based on the rewritten guide query, one or more functions for performing an operation of turning on TV may be retrieved. The first sub-module 120 may execute the retrieved one or more functions, and may obtain a value corresponding to the blank field ‘$TV$’, based on a result of the execution. For example, the first sub-module 120 may retrieve a function for turning on a TV, may execute the retrieved function, and may obtain a value ‘ON’ indicating that the TV is turned on. The first sub-LM 122 may generate a response (e.g., ‘Response 1: “{$TV$: ON}”’) including a value corresponding to the blank field ‘$TV$’, and may transmit the generated response to the LLM 110.

The second sub-LM 132 may identify that the second sub-module 130 has to perform an operation of searching for fine dust density and an operation of turning on air purifier when a particular condition is satisfied, and to return values corresponding to the blank queries ‘$DUST$’, ‘$COND$’, and ‘$AIR$’ to the LLM 110, based on ‘Plan 2’ and ‘Guide query 2’. The second sub-LM 132 may rewrite ‘Guide query 2’ by considering the current specification of the second sub-module 130. Based on the rewritten guide query, one or more functions for performing the operation of searching for fine dust density and the operation of turning on air purifier may be retrieved. The second sub-module 130 may execute the retrieved one or more functions, and may obtain the values corresponding to the blank queries ‘$DUST$’, ‘$COND$’, and ‘$AIR$’, based on a result of the execution. For example, the second sub-module 130 may obtain ‘80’ as a value of ‘$DUST$’, may identify that fine dust density does not exceed a predefined threshold, based on the obtained value of ‘$DUST$’, and may determine a value of a precedent condition ‘$COND$’ for an operation of turning on air purifier as ‘Bad’. Based on the value of precedent condition ‘$COND$’ being as ‘Bad’, the second sub-module 130 may turn on the air purifier 14, according to ‘Plan 2’, and the second sub-LM 132 may generate a response (e.g., ‘Response 2: “{$DUST$: 80, ‘$COND$: Bad, ‘$AIR$: ON}”’) including the values corresponding to the blank queries ‘$DUST$’, ‘$COND$’, and ‘$AIR$’ and may transmit the generated response to the LLM 110.

The LLM 110 may fill the plan query, based on a response from each sub-module. For example, the LLM 110 may fill (or replace, substitute) the blank queries ‘$DUST$’, ‘$COND$’, and ‘$AIR$’ in the plan query ‘Turning on TV. Result: $TV$. Fine dust density: $DUST$, Density state: $COND$, If $COND$ is bad, turn on air purifier. Result: $AIR$.’ with values indicated by ‘Response 1’ and ‘Response 2’. The plan query filled by the LLM 110 may be ‘Turning on TV. Result: ON. Fine dust density: 80, Density state: Bad, If Density state is bad, turn on air purifier. Result: ON.’. Based on the filled plan query, the LLM 110 may generate the final response 114 to the input query 112. For example, based on the filled plan query ‘Turning on TV. Result: ON. Fine dust density: 80, Density state: Bad, If Density state is bad, turn on air purifier. Result: ON.’, the LLM 110 may generate the final response 114 indicating that a TV is turned on, and an air purifier is turned on because Density state is bad. The final response 114 may be ‘TV is turned on. Air purifier is turned on because fine dust density is bad at 80’.

According to an embodiment of the disclosure, instead that one LM having received an input query performs all of planning, query rewriting, operation execution command, reasoning, and final response generation, two or more LMs may perform the aforementioned features in a distributed manner. For example, the LLM 110 may establish a plan based on the input query 112, may provide the plan and a related query to each sub-module, may perform reasoning on a response from each sub-module, and may generate a final response. The sub-LM 122/132 of each sub-module may rewrite a query to be appropriate for each sub-module, the query being from the LLM 110, may generate command(s) to perform one or more operations indicated by an input query, and may provide a result of performing the operations to the LLM 110. The plurality of sub-modules 120 and 130 including the plurality of sub-LMs 122 and 132 may operate in parallel, and thus, the speed of the LLM-based system 100 may be improved. As features and/or roles are distributed to a plurality of LMs, a training load of each LM may be decreased, a response time may be improved, and occurrence of hallucination may be prevented. Each sub-module may include a module-specific sub-LM trained based on features supported by each sub-module. When the specification of a sub-module is changed, the module-specific sub-LM may be updated, instead of re-training one LLM. Therefore, it is possible to provide an LM that is capable of easily following up characteristics of a device or an application connected to the LLM-based system 100, and that has high accuracy and fast speed, despite of changed specifications.

According to an embodiment of the disclosure, in order to generate a plan, the LLM 110 may determine a module-dependent element or a not-defined value (element) as a blank field or a blank query. For example, the LLM 110 may replace an element to have an actual value, an element having a value varying depending on a result of a preceding operation, an element having an in-domain attribute related to particular device/equipment/application and/or a particular condition (e.g., a precedent condition of a random operation) by dummy values, and may represent the elements as blank queries in a plan query). The LLM 110 may establish a plan query including one or more blank queries, and may provide each sub-module with a part or all parts of the plan query related to each sub-module, in parallel (or concurrently). For example, the LLM 110 may provide ‘first plan’ to the first sub-module 120, and in parallel, may provide ‘second plan’ to the second sub-module 130. As a module-dependent element or a not-defined value (element) is determined as a blank field when establishing a plan, the LLM 110 may generate a domain-agnostic plan. Accordingly, the plan query generated by the LLM 110 may be provided to each sub-module concurrently in parallel, or at least in part. The LLM 110 is capable of further focusing on planning from among planning and value extraction, and thus, a plan generated by the LLM 110 may be improved.

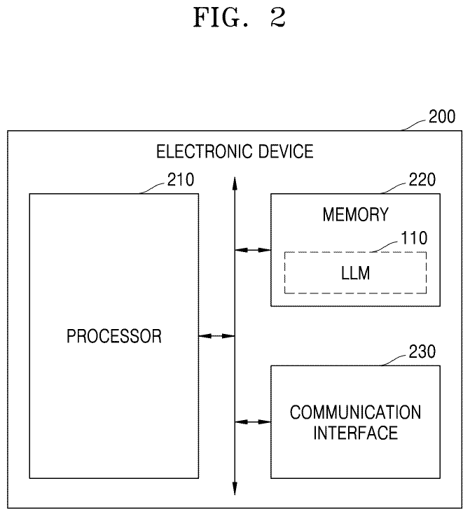

FIG. 2 is a block diagram of an example of an electronic device 200 according to an embodiment of the disclosure.

Referring to FIG. 2, the electronic device 200 may include a processor 210, memory 220, and a communication interface 230. FIG. 2 illustrates only essential elements for describing functions and/or operations of the electronic device 200, and elements included in the electronic device 200 are not limited to what are shown in FIG. 2. The configuration of the electronic device 200 shown in FIG. 2 is exemplary, and an example of the electronic device 200 which performs an embodiment of the disclosure is not limited to the configuration shown in FIG. 2. In an embodiment of the disclosure, one or more configurations shown in FIG. 2 may be deleted or changed, or a configuration not shown in FIG. 2 may be added to the electronic device 200.

The processor 210 may execute one or more instructions or one or more program codes stored in the memory 220. For example, the processor 210 may execute the LLM 110 stored in the memory 220. The processor 210 may include a hardware element that performs arithmetic, logic, and input and output operations. Referring to FIG. 2, the processor 210 is shown as one element, but the disclosure is not limited thereto. In an embodiment of the disclosure, the processor 210 may include one or more elements.

The processor 210 may include various types of processing circuitry and/or a plurality of processors. For example, the term “processor” used herein including claims may include at least one processor, and additionally or alternatively may include various types of processing circuitry. One or more processors may be configured to individually in a distributed manner and/or collectively perform various functions described in the disclosure. As used herein, “processor”, “at least one processor”, and “one or more processors” may be configured to perform various functions. However, the recited terms cover a situation in which one processor performs a part of functions and other processor(s) performs the other part of the functions, and a situation in which one processor may perform all functions. Also, the at least one processor may include a combination of processors configured to perform a variety of the disclosed functions in a distributed manner. The at least one processor may individually or collectively execute program instructions to achieve or perform various functions.

The processor 210 may be implemented as a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). The processor 210 may control input data to be processed, according to predefined operating rules or an AI model. Alternatively, when the processor 210 is an AI-dedicated processor, the AI-dedicated processor may be designed in a hardware structure specialized for processing a particular AI model.

The memory 220 may store instructions, a data structure, and program code, which are readable by the processor 210. For example, the memory 220 may store the LLM 110 readable (or executable) by the processor 210. In an embodiment of the disclosure, the memory 220 may store instructions that, when executed by the processor 210 individually or collectively (e.g., collectively by a plurality of processors), cause the electronic device 200 to perform at least a part of operations to be described below. For example, the processor 210 may execute one or more instructions or codes stored in the memory 220 to perform at least a part of operations of the electronic device 200 described in the disclosure.

The memory 220 may include a flash memory, a hard disk, a multimedia card micro type memory, or a card-type memory. The memory 220 may include a non-volatile memory including at least one of read-only memory (ROM), electrically erasable programmable read-only memory (EEPROM), programmable read-only memory (PROM), magnetic memory, magnetic disk, or optical disk, and/or a volatile memory such as dynamic random access memory (DRAM) or static random access memory (SRAM).

In an embodiment of the disclosure, the memory 220 may store one or more instructions or program codes to execute the LLM 110. The memory 220 may store one or more instructions and/or program codes to cause the electronic device 200 to generate the final response 114 from the input query 112 of FIG. 1 by using the LLM 110. However, elements stored in the memory 220 are only for convenience of descriptions and are not limited thereto.

The communication interface 230 may perform data communication with an external device, under the control of the processor 210. For example, the communication interface 230 may receive the input query 112 from the external device, and may transmit the final response 114 to the external device. In an embodiment of the disclosure, the communication interface 230 may include communication circuitry (various types of communication circuitry) configured to perform data communication between the electronic device 200 and other electronic devices by using at least one of data communication schemes including wired local area network (LAN), wireless LAN, Wi-Fi, Bluetooth, ZigBee, Wi-Fi direct (WFD), infrared data association (IrDA), Bluetooth low energy (BLE), Near Field Communication (NFC), wireless broadband Internet (WiBro), World interoperability for microwave access (WiMAX), shared wireless access protocol (SWAP), wireless gigabit alliance (WiGig), and radio frequency (RF) communication.

According to an embodiment of the disclosure, the electronic device 200 may additionally include a user interface configured to obtain the input query 112 from a user and provide the final response 114 to the user. For example, the electronic device 200 may additionally include at least one of various input devices such as a keyboard, a mouse, a microphone, or a touch screen. The electronic device 200 may additionally include at least one of various output devices such as a display device or a speaker.

According to an embodiment of the disclosure, the electronic device 200 may include the at least one processor 210 including processing circuitry, and the memory 220 including one or more storage media and storing one or more instructions. The one or more instructions, when executed by the at least one processor individually or collectively, may cause the electronic device 200 to obtain an input query. The one or more instructions, when executed by the at least one processor individually or collectively, may cause the electronic device 200 to generate, by using the LLM 110, based on the input query, a plan query including one or more blank queries to be filled with values related to a sub-module including a sub-LM and one or more operations to be performed by the sub-module. For example, the electronic device 200 may generate, by using the LLM 110, based on the input query, a plan query comprising one or more blank queries related to a first sub-module and one or more operations to be performed by the first sub-module, the first sub-module comprising a sub-LM. The one or more instructions, when executed by the at least one processor individually or collectively, may cause the electronic device 200 to transmit, to the sub-module, a request for returning one or more values corresponding to the one or more blank queries and at least a part of the plan query with a first guide query at least partly based on a part of the input query which is related to the sub-module. For example, the electronic device 200 may transmit, to the first sub-module, (a) a request for generating a first response comprising one or more values corresponding to the one or more blank queries, (b) at least a part of the plan query, and (c) a first guide query, the first guide query being based on a part of the input query associated with the first sub-module. The one or more instructions, when executed by the at least one processor individually or collectively, may cause the electronic device 200 to receive, from the sub-module, a first response generated by using the sub-LM and including the one or more values. For example, the electronic device 200 may receive, from the first sub-module, the first response generated by using the sub-LM of the first sub-module, the first response comprising the one or more values. The one or more instructions, when executed by the at least one processor individually or collectively, may cause the electronic device 200 to generate, by using the LLM 110, a final response to the input query, based on the first response.

Additionally or alternatively, a first blank field among the one or more blank queries may correspond to at least one of an actual value to be obtained from the sub-module, a value dependent on a state of the sub-module, a value dependent on an attribute of the sub-module, a value indicating a result of any one of the one or more operations, or a condition indicated by the input query.

Additionally or alternatively, the one or more instructions, when executed by the at least one processor individually or collectively, may cause the electronic device 200 to obtain, from the LLM 110, a list of one or more functions to be performed by the sub-module, based on the input query. The one or more instructions, when executed by the at least one processor individually or collectively, may cause the electronic device 200 to modify, by an agnostic checker, the list, based on at least a part of function update information indicating functions currently supported by the sub-module and a deprecated version handling policy including a handling policy of one or more functions that are deprecated. The one or more instructions, when executed by the at least one processor individually or collectively, may cause the electronic device 200 to transmit the modified list of to the sub-module.

Additionally or alternatively, the one or more instructions, when executed by the at least one processor individually or collectively, may cause the electronic device 200 to fill, by the agnostic checker, at least one blank field included in the plan query, based on a value received from the sub-module, the value being previously stored in the agnostic checker. For example, the electronic device 200 may modify, by the agnostic checker, the plan query, based on a value corresponding to one of the one or more blank queries, the value being previously stored in the agnostic checker. The one or more instructions, when executed by the at least one processor individually or collectively, may cause the electronic device 200 to transmit, to the sub-module, the plan query that is at least partly filled. For example, the electronic device 200 may transmit, to the sub-module, the modified plan query.

Additionally or alternatively, the plan query may include a first operation to be performed by the sub-module, the first operation being indicated by the input query, and a third blank field to be filled with a third value indicating whether a precedent condition of the first operation is satisfied. For example, the plan query comprises a first operation to be performed by the first sub-module, the first operation being indicated by the input query, and a third blank query associated with a third value indicating whether a precedent condition of the first operation is satisfied. The one or more instructions, when executed by the at least one processor individually or collectively, may cause the electronic device 200 to transmit, to the sub-module, the first guide query with a request for returning a third value corresponding to the third blank field. For example, the electronic device 200 may transmit, to the first sub-module, the first guide query with a request for generating the first response comprising the third value corresponding to the third blank query. The one or more instructions, when executed by the at least one processor individually or collectively, may cause the electronic device 200 to identify waiting for performance of the first operation. The one or more instructions, when executed by the at least one processor individually or collectively, may cause the electronic device 200 to, based on identifying the waiting for performance of the first operation, generate, by using the LLM 110, a first subsequent plan query for which it is supposed that the precedent condition of the first operation is satisfied, and a second subsequent plan query for which it is supposed that the precedent condition of the first operation is not satisfied. The first subsequent plan query and the second subsequent plan query may include the third blank field.

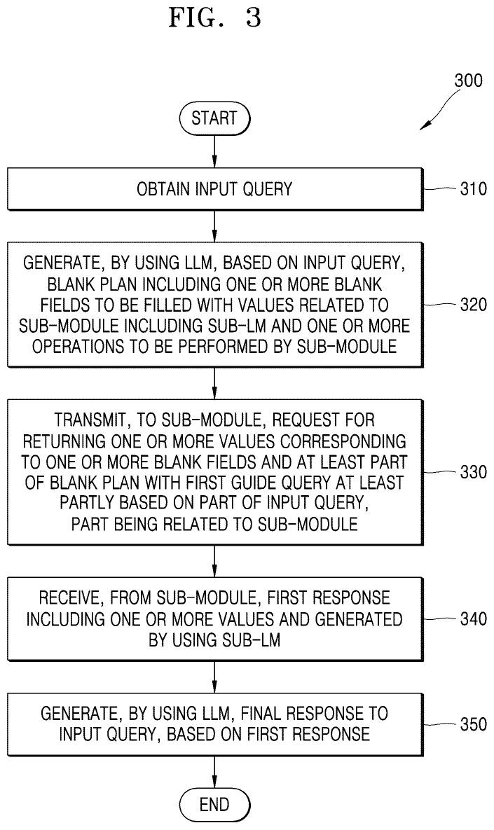

FIG. 3 is a flowchart of an example of a method 300 according to an embodiment of the disclosure.

Referring to FIG. 3, the method 300 may include operations 310, 320, 330, 340, and 350. According to an embodiment of the disclosure, the method 300 may be performed by the electronic device 200 of FIG. 2. However, the disclosure is not limited thereto, and operations 310, 320, 330, 340, and 350 may be individually or collectively performed by a random electronic device. The method according to an embodiment of the disclosure is not limited to what is shown in FIG. 3, and may exclude any one of operations shown in FIG. 3 or may further include one or more operations not shown in FIG. 3. In some embodiments of the disclosure, an order of operations 310, 320, 330, 340, and 350 may be changed at least in part.

In operation 310, the electronic device 200 may obtain an input query. For example, the electronic device 200 may obtain a natural language-type query having one or more goals, as that of the input query 112 of FIG. 1. In an embodiment of the disclosure, the electronic device 200 may obtain an input query from an external electronic device (e.g., a user terminal). In an embodiment of the disclosure, the electronic device 200 may additionally include a user interface, and may receive an input query from a user by using the user interface.

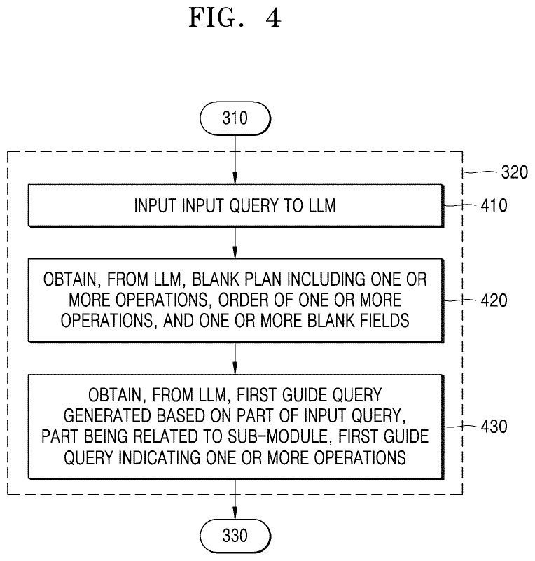

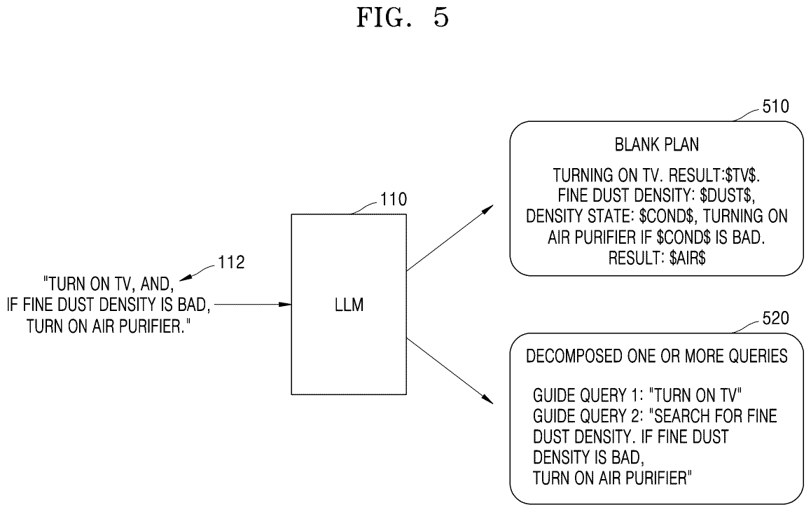

In operation 320, the electronic device 200 may generate, by using the LLM 110, a plan query based on the obtained input query. The plan query may include one or more blank queries to be filled with values related to a sub-module including a sub-LM. The plan query may include one or more operations to be performed by the sub-module. For example, the electronic device 200 may generate the plan query including ‘Plan 1’ and ‘Plan 2’ of FIG. 1. The plan query may include the blank field ‘$TV$’ to be filled with a value related to the first sub-module 120 including the first sub-LM 122, and an operation of ‘Turning on TV’ to be performed by the first sub-module 120. The plan query may include the blank queries ‘$DUST$’, ‘$COND$’, and ‘$AIR$’ to be filled with values related to the second sub-module 130 including the second sub-LM 132, and operations of ‘Searching for fine dust density’ and ‘Turning on air purifier if fine dust density is bad’ to be performed by the second sub-module 130. Detailed operations of operation 320 will be described in detail below with reference to FIGS. 4 and 5.

In operation 330, the electronic device 200 may transmit a request for returning one or more values corresponding to one or more blank queries to the sub-module. The electronic device 200 may transmit at least a part of the plan query to the sub-module. The electronic device 200 may transmit, to the sub-module, a first guide query at least partly based on a part of the input query, the part being related to the sub-module. For example, the electronic device 200 may transmit, to the first sub-module 120, a request for returning a value corresponding to the blank field ‘$TV$’, ‘Plan 1’, and ‘Guide query 1’ generated based on the input query 112. For example, the electronic device 200 may transmit, to the second sub-module 130, a request for returning values corresponding to the blank queries ‘$DUST$’, ‘$COND$’, and ‘$AIR$’, ‘Plan 2’, and ‘Guide query 2’ generated based on the input query 112.

In operation 340, the electronic device 200 may receive, from the sub-module, a first response including one or more values and generated by using the sub-LM. For example, the electronic device 200 may receive, from the first sub-module 120, ‘Response 1’ that is generated by using the first sub-LM 122 and includes ‘ON’ that is a value corresponding to the blank field ‘$TV$’. The electronic device 200 may receive, from the second sub-module 130, ‘Response 2’ that is generated by using the second sub-LM 132 and includes ‘80’, ‘Bad’, and ‘ON’ that are values corresponding to the blank queries ‘$DUST$’, ‘$COND$’, and ‘$AIR$’.

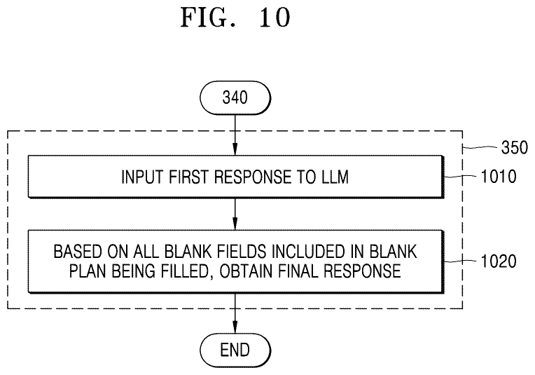

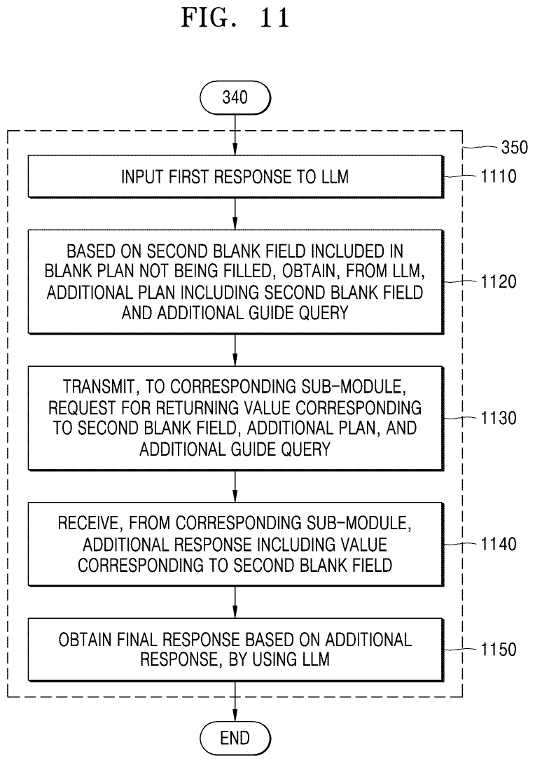

In operation 350, the electronic device 200 may generate, by using the LLM 110, a final response to the input query, based on the first response. For example, the electronic device 200 may generate the final response 114 of FIG. 1, based on ‘Response 1’ and ‘Response 2’. Detailed operations of operation 350 will be described in detail below with reference to FIGS. 10 and 11.

According to an embodiment of the disclosure, a first blank field among the one or more blank queries may correspond to at least one of an actual value to be obtained from the sub-module, a value dependent on a state of the sub-module, a value dependent on an attribute of the sub-module, a value indicating a result of any one of the one or more operations, or a condition indicated by the input query.

FIG. 4 is a flowchart of an example of an operation of generating a plan query, according to an embodiment of the disclosure.

Referring to FIG. 4, operation 320 of FIG. 3 may include operations 410, 420, and 430. According to an embodiment of the disclosure, operations 410, 420, and 430 may be performed by the electronic device 200 of FIG. 2. However, the disclosure is not limited thereto, and operations 410, 420, and 430 may be individually or collectively performed by a random electronic device. The generation of the plan query according to an embodiment of the disclosure is not limited to what is shown in FIG. 4, and may exclude any one of operations shown in FIG. 4 or may further include one or more operations not shown in FIG. 4. In some embodiments of the disclosure, an order of operations 410, 420, and 430 may be changed at least in part.

In operation 410, the electronic device 200 may input an input query to the LLM 110. For example, the electronic device 200 may input the input query 112 of FIG. 1 to the LLM 110.

In operation 420, the electronic device 200 may obtain a plan query from the LLM 110. The plan query may include one or more operations, an order of one or more operations, and one or more blank queries. The LLM 110 may analyze the input query input in operation 410. The LLM 110 may determine a goal indicated by the input query, may establish a plan query to achieve the determined goal, and may output the established plan query. In order to generate a plan, the LLM 110 may determine one or more operations to be performed to achieve the goal, and may determine a performing entity of each operation.

According to an embodiment of the disclosure, the LLM 110 may decompose the input query into two or more queries, and may sequentially establish plans respectively for the decomposed queries. For example, when the input query corresponds to ‘Turn on TV and air conditioner, and if fine dust density is bad, turn on air purifier and send message of the value to Mom’, the LLM 110 may first divide the input query into ‘Turn on TV and air conditioner, and if fine dust density is bad, turn on air purifier’ and ‘Text the value to Mom’. Afterward, the LLM 110 may establish a first plan query such as ‘Turn on TV. Result: $TV$, Turn on air conditioner. Result: $AC$, Fine dust density: $DUST$, Density state: $DENSITY$ Air purifier: $COND$($AIR$→ON, Else→OFF)’, based on the divided query ‘Turn on TV and air conditioner, and if fine dust density is bad, turn on air purifier’. The blank field ‘$TV$’ may be filled with a value indicating a result of performing ‘Turn on TV’. The blank field ‘$AC$’ may be filled with a value indicating a result of performing ‘Turn on air conditioner’. The blank field ‘$DUST$’ may be filled with an actual value of ‘Fine dust density’. The blank field ‘$DENSITY$’ may be filled based on comparison between the actual value of ‘$DUST$’ and a predefined threshold value. The blank field ‘$COND$’ may be filled with a value indicating whether a condition of turning on an air purifier has been satisfied. The blank field ‘$AIR$’ may be filled with a value indicating a result of performing ‘Turn on air purifier’. Afterward, the LLM 110 may establish a second plan query such as ‘IF $DENSITY$ is bad, send message of $DUST$ to $TO$. Result: $SendSuccess$’, based on the divided query ‘Send message of the value to Mom’. The blank field ‘$TO$’ may be an object of ‘Send message’. The blank field ‘$SendSuccess$’may be filled with a value indicating a result of performing ‘Send message’.

In operation 430, the electronic device 200 may obtain, from the LLM 110, a first guide query that is generated based on the part of the input query, the part being related to a sub-module and indicating one or more operations. The LLM 110 may generate a guide query for each sub-module, based on the input query. The LLM 110 may decompose the input query for each sub-module. The LLM 110 may provide each sub-module with a decomposed input query related to each sub-module, as a guide query.

According to an embodiment of the disclosure, a ‘guide query’ may be a query generated based on an input query so as to indicate (or notify or inform) one or more operations to a corresponding sub-module. A sub-module may execute one or more operations, based on the guide query and all or some parts of the received plan query. By providing the guide query, instead of the entire input query, the sub-module may easily identify operations that it has to perform.

For example, the LLM 110 may decompose the input query 112 of FIG. 1 into a part ‘Turn on TV’ related to the first sub-module 120 related to the TV 12 and a part ‘If fine dust density is bad, turn on air purifier’ related to the second sub-module 130 related to the air purifier 14. Based on the part ‘Turn on TV’ related to the first sub-module 120, the LLM 110 may generate ‘Guide query 1’ such as ‘Turn on TV’. Based on the part ‘If fine dust density is bad, turn on air purifier’ related to the second sub-module 130, the LLM 110 may generate ‘Guide query 2’ such as ‘Search for fine dust density. If fine dust density is bad, turn on air purifier’.

According to an embodiment of the disclosure, the LLM 110 may generate a guide query at least partly based on one or more queries received before the input query. The LLM 110 may generate the guide query by considering the pre-received queries and the context of a current input query. For example, when a pre-received query ‘If fine dust density is bad, turn on air purifier’ and an input query ‘air conditioner and electric fan, too. Not TV’ are given, the LLM 110 may generate guide queries, based on the input query, in consideration of the pre-received query. The LLM 110 may decompose the input query into ‘air conditioner and electric fan, too’ and ‘Not TV’, by considering the input query. The pre-received query may include a condition ‘if fine dust density is bad’, and the LLM 110 may identify that the condition is at least partly elated to the current input query. Therefore, in order to notify a condition of an operation, the LLM 110 may provide, as the guide query, ‘If fine dust density is bad, turn on air purifier. Air conditioner and electric fan, too.’ to a sub-module related to an air conditioner and a sub-module related to an electric fan. In addition, ‘Air conditioner and electric fan, too’ of the input query may indicate an operation irrelevant to TV. Therefore, in order to allow a sub-module related to TV to focus on its own operation, the LLM 110 may provide, as the guide query, ‘If fine dust density is bad, turn on air purifier. Not TV.’ to the sub-module related to TV.

According to an embodiment of the disclosure, the LLM 110 may transmit a guide query and a corresponding part of the plan query to each sub-module and may also request each sub-module for one or more values that have to be returned. The LLM 110 may provide each sub-module with meta information of a value that has to be returned. For example, when a pre-received query ‘If fine dust density is bad, turn on air purifier’ and an input query ‘air conditioner and electric fan, too. Not TV’ are given, the LLM 110 may transmit a context history (e.g., the pre-received query) and ‘If fine dust density is bad’ to the air purifier and may request the air purifier with a value of densities ‘$DUST$’.

FIG. 5 illustrates an example of an operation for generating a plan query, according to an embodiment of the disclosure.

Referring to FIG. 5, the LLM 110 may receive the input query 112. Based on the received input query 112, the LLM 110 may output a plan query 510 and one or more decomposed queries 520. Based on the input query 112, the LLM 110 may generate the plan query 510 including one or more blank queries. For example, the LLM 110 may determine to analyze the input query 112 and to perform a TV's operation of turning on TV and an air purifier's operation of searching for fine dust density and turning on air purifier. The LLM 110 may determine an order of operations to be performed. The LLM 110 may determine one or more blank queries by considering operations to be performed and an order of the operations. For example, the LLM 110 may determine, as blank queries, a result value of the operation of turning on TV, an actual value of found fine dust density, a condition ‘if fine dust density is bad’ included in the input query 112, and a result value of the operation of turning on air purifier. The LLM 110 may generate the plan query 510, based on the operations to be performed, the order of operations, and the determined blank queries. For example, the plan query 510 generated based on the input query 112 may correspond to ‘Turning on TV. Result: $TV$. Fine dust density: $DUST$, Density state: $COND$, Turning on air purifier if $COND$ is bad. Result: $AIR$’.

The LLM 110 may decompose the input query 112 for each sub-module, and may generate the decomposed one or more queries 520, based on the decomposed input query. The decomposed one or more queries 520 may include a guide query for notifying one or more operations to each sub-module. For example, the LLM 110 may decompose the input query 112 into ‘Turn on TV’ including an operation that has to be performed by a TV and ‘If fine dust density is bad, turn on air purifier’ including an operation that has to be performed by an air purifier. The LLM 110 may generate ‘Guide query 1’ for a sub-module related to TV, based on ‘Turn on TV’ among the decomposed queries. ‘Guide query 1’ generated by the LLM 110 may correspond to ‘Turn on TV’. The LLM 110 may generate ‘Guide query 2’ for a sub-module related to air purifier, based on ‘If fine dust density is bad, turn on air purifier’ among the decomposed queries. ‘Guide query 2’ generated by the LLM 110 may correspond to ‘Search for fine dust density. If fine dust density is bad, turn on air purifier’. The guide query may help identify an operation that a corresponding sub-module has to perform.

According to an embodiment of the disclosure, the LLM 110 may be trained to establish an entire plan based on a given input query and to determine, as a blank field or a place holder, a module-dependent part or a not-defined part. The LLM 110 may be trained to transform a given input query to be appropriate for each sub-module. According to an embodiment of the disclosure, the LLM 110 may be obtained by fine tuning a pre-trained LM by using appropriate datasets.

For example, the LLM 110 may be trained by using an instruction following (IF) dataset including a pair of a given input and an output corresponding thereto. The IF dataset may be a dataset generally used to train an LM. The IF dataset may include data for training the LM to appropriately respond according to a particular command or instruction. For example, the IF dataset may include pairs of various inputs such as queries, requests, commands, etc., and pre-generated appropriate outputs. The IF dataset may include not only data for each sub-module but also include data for a domain that is a set of sub-modules. The IF dataset may include data related to usage (e.g., planning or reasoning) on domain data.

Additionally or alternatively, the LLM 110 may be trained by using a basic specification dataset including the specification of each sub-module. For example, the basic specification dataset may include data of specifications of sub-modules in the domain or entities connected to the LLM-based system 100, such as the data including one or more functions supported by each sub-module in the domain, a format of a command or instruction supported in each sub-module, and/or one or more features supported by each device, equipment, and/or application connected to the LLM-based system 100.

Additionally or alternatively, the LLM 110 may be trained by using planning datasets including planning scenarios for which an interaction between one or more sub-modules is considered. The planning dataset may include data for plans established for a given query by considering a relation between sub-modules in the domain.

The LLM 110 may be trained using a supervised fine-tuning (STF) scheme by using the IF dataset, the basic specification dataset, and/or the planning dataset. For example, to implement the LLM 110, based on the IF dataset, the basic specification dataset, and/or the planning dataset, a pre-trained LM may be additionally trained on a process of establishing a plan for performing an input query from a user and an appropriate response to the plan when domain data (e.g., information about each sub-module included in the LLM-based system 100) is given. For example, via the SFT using the IF dataset, the basic specification dataset, and/or the planning dataset, the pre-trained LM may be additionally trained on basic planning capacity using a sub-module and basic specifications of a current domain that is a learning (or training) target.

Additionally or alternatively, the LLM 110 may be trained by using a sample dataset including a user query, one or more plans for a given query, and sets of execution pipelines. The sample dataset may include: a data sample including at least one of an example input query, an entire plan established for the example input query, a plan query established for the example input query, a guide query for each sub-module, subsequent entire plan(s) established for the example input query, subsequent plan query(ies) established for the example input query, or an example final response to the example input query. For example, the data sample may include at least one of an example input query such as ‘Turn on TV and air conditioner, and if fine dust density is bad, turn on air purifier and send message of the value to Mom’; an entire plan such as ‘Turning on TV. Result: ON, Turning on air conditioner. Result: ON, Fine dust density: 80, Density state: Bad, Air purifier: Bad→ON, Else→OFF’; a plan query such as ‘Turning on TV. Result: $TV$, Turning on air conditioner. Result: $AC$, Fine dust density: $DUST$, Density state: $DENSITY$ Air purifier: $COND$($AIR$→ON, Else→OFF)’; one or more guide queries such as ‘Turn on TV’, ‘Turn on air conditioner’, or ‘Search for fine dust density. Turn on air purifier’; a subsequent plan such as ‘If Density state: Bad is bad, send message of Fine dust density: 80 to Mom. Result: Sent’; a subsequent plan query such as ‘If $DENSITY$ is bad, text $DUST$ to $TO$. Result: $SendSuccess$’; or a final response such as ‘TV and air conditioner are turned on, and as fine dust density is bad as 80, air purifier is also turned on. Fine dust density is texted to Mom’.

According to an embodiment of the disclosure, the LLM 110 may be trained via the STF scheme by using the data sample and one or more data samples transformed from the data sample. For example, the LLM 110 may be trained via the STF scheme by including, in the same batch, one or more pairs of a first data sample in which all blank queries in the plan query included in the data sample are filled, a second data sample corresponding to the data sample, and a third data sample obtained by removing the entire plan and/or the subsequent entire plan(s) from the data sample. For example, at least some of a pair of the first data sample and the second data sample, a pair of the second data sample and the third data sample, or a pair of the first data sample and the third data sample are included in the same batch so as to train and implement the LLM 110.

For example, as being trained by including the pair of the first data sample and the second data sample in the same batch, the LLM 110 may be trained to apply a blank field to each of one or more particular elements in a plan. Based on the first data sample not including a dummy value and the second data sample including the dummy value (e.g., blank field), the LLM 110 may be trained to identify fields filled with dummy values. As being trained by including the pair of the second data sample including the plan query and the third data sample not including the entire plan and/or the subsequent entire plan(s) in the same batch, the LLM 110 may be trained to establish the plan query while maintaining planning capacity. As being trained by including the pair of the first data sample not including the dummy value and the third data sample not including the entire plan and/or the subsequent entire plan(s) in the same batch, the LLM 110 may be trained to directly generate a plan query from the ground truth in which blank queries are filled, and also, overfitting due to the second data sample may be prevented.

By using at least one of the pair of the first data sample and the second data sample, the pair of the second data sample and the third data sample, or the pair of the first data sample and the third data sample, plan-optional required plan query training may be performed on the LLM 110. Accordingly, the LLM 110 may be trained to generate a plan query by considering an entire plan. The LLM 110 may be trained to establish the plan query and may concurrently maintain planning capacity. The LLM 110 may be trained to generate a module-independent plan, so that module portability or applicability across modules may be improved. For example, even when the specification of a random module is changed, occurrence of hallucination due to re-training may be prevented in the LLM 110, and scalability of the LLM 110 may be improved.

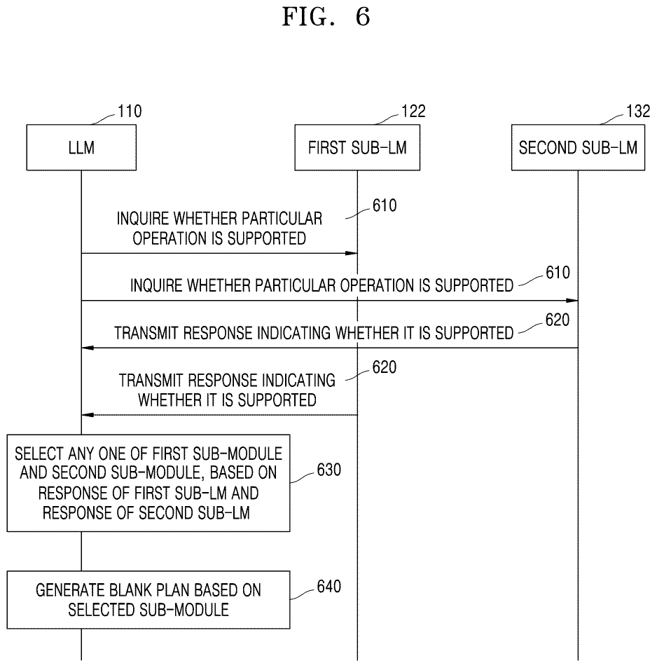

FIG. 6 is a flowchart of an example of a method 600 of generating a plan query, according to an embodiment of the disclosure.

Referring to FIG. 6, the LLM 110 may perform operations 610, 630, and 640. The first sub-LM 122 and the second sub-LM 132 may perform operation 620. However, the disclosure is not limited thereto, and operations 610, 620, 630, and 640 may be individually or collectively performed by a random electronic device. The method according to an embodiment of the disclosure is not limited to what is shown in FIG. 6, and may exclude any one of operations shown in FIG. 6 or may further include one or more operations not shown in FIG. 6. In some embodiments of the disclosure, an order of operations 610, 620, 630, and 640 may be changed at least in part.

According to an embodiment of the disclosure, the LLM 110 may perform natural language conversation for delegating at least one operation to the first sub-LM 122 or the second sub-LM 132. For example, with respect to the at least one operation, the LLM 110 may generate a natural language prompt, may transmit the generated natural language prompt to the first sub-LM 122 and/or the second sub-LM 132, and may obtain responses to the natural language prompt from the first sub-LM 122 and/or the second sub-LM 132, thereby performing the natural language conversation with the first sub-LM 122 and/or the second sub-LM 132. For example, the LLM 110 may transmit, to the first sub-LM 122 and/or the second sub-LM 132, the natural language prompt (e.g., natural language query) for inquiring whether the at least one operation is supported. In response to the natural language prompt from the LLM 110, the first sub-LM 122 and/or the second sub-LM 132 may generate a natural language response (or answer) to the natural language prompt, and may transmit the generated natural language prompt to the LLM 110. Based on the response from the first sub-LM 122 and/or the second sub-LM 132, the LLM 110 may delegate the at least one operation to the first sub-LM 122 and/or the second sub-LM 132. In an embodiment of the disclosure, until establishment of the plan query is completed, the LLM 110 may perform the natural language conversation with the first sub-LM 122 and/or the second sub-LM 132.

For example, in operation 610, the LLM 110 may inquire whether a particular operation is supported by the first sub-LM 122 and the second sub-LM 132. The LLM 110 may analyze an input query, and may identify one or more operations indicated by the input query. In order to identify a sub-module for supporting a particular operation (or, a feature, a function) among the identified one or more operations, the LLM 110 may inquire of the first sub-LM 122 of the first sub-module 120 and the second sub-LM 132 of the second sub-module 130 whether a particular operation is supported by each sub-module. For example, the LLM 110 may generate a natural language prompt to inquire whether the particular operation is supported by each sub-module. The LLM 110 may transmit the generated natural language prompt to the first sub-LM 122 and the second sub-LM 132.

In operation 620, each sub-LM may transmit, to the LLM 110, a response indicating whether the particular operation is supported by a corresponding sub-module. For example, in response to the inquiry from the LLM 110, the first sub-LM 122 may identify whether the particular operation is supported by the first sub-module 120. Based on identifying that the particular operation is supported by the first sub-module 120, the first sub-module 120 may generate a response indicating that the particular operation is supported by the first sub-module 120. For example, the first sub-module 120 may generate, as the response, a natural language prompt indicating that the particular operation is supported by the first sub-module 120. Based on identifying that the particular operation is not supported by the first sub-module 120, the first sub-module 120 may generate a response indicating that the particular operation is not supported by the first sub-module 120. The first sub-LM 122 may transmit the generated response to the LLM 110. Similarly, the second sub-LM 132 may generate a response to an inquiry from the LLM 110, and may transmit the generated response to the LLM 110.

In operation 630, based on the response of the first sub-LM 122 and the response of the second sub-LM 132, the LLM 110 may select any one of the first sub-module 120 and the second sub-module 130. For example, based on the response of the first sub-LM 122 and the response of the second sub-LM 132, the LLM 110 may identify a sub-module that supports the particular operation. With respect to the particular operation, the LLM 110 may select a sub-LM included in the sub-module that supports the particular operation. In operation 640, the LLM 110 may generate a plan query based on the selected sub-module. The LLM 110 may determine the selected sub-module to be a performing entity for the particular operation, and may generate the plan query including the particular operation.

For example, in operation 620, based on identifying that the particular operation is supported by the first sub-module 120, the first sub-LM 122 may transmit, to the LLM 110, the response indicating that the particular operation is supported by the first sub-module 120. Based on identifying that the particular operation is not supported by the second sub-module 130, the second sub-LM 132 may transmit, to the LLM 110, a response indicating that the particular operation is supported by the second sub-module 130. In operation 630, based on the response indicating that the particular operation is supported by the first sub-module 120, the response being from the first sub-LM 122, and the response indicating that the particular operation is supported by the second sub-module 130, the response being from the second sub-LM 132, the LLM 110 may select the first sub-module 120 to be a performing entity of the particular operation. In operation 640, based on selecting the first sub-module 120 to be the performing entity of the particular operation, the LLM 110 may generate the plan query including the particular operation. The plan query generated by the LLM 110 may indicate that the particular operation is to be performed by the first sub-module 120.

In an embodiment of the disclosure, the LLM 110, the first sub-LM 122, and/or the second sub-LM 132 may perform a natural language conversation to provide information to each other. For example, in order to identify a feature or an operation supported by a random sub-module, the LLM 110 may transmit a natural language inquiry for a feature or an operation supported by a sub-module to a corresponding sub-LM. The sub-LM having received the natural language inquiry from the LLM 110 may identify a feature or an operation supported by the corresponding sub-module, may generate a natural language response to the natural language inquiry, based on the identifying, and may transmit the generated natural language response to the LLM 110. The natural language response generated by the sub-LM may include information about the feature or the operation supported by the sub-module. Via a natural language conversation with a sub-LM, the LLM 110 may identify a feature or an operation supported by the sub-module. Based on the natural language conversation with the sub-LM, the LLM 110 may determine a performing entity for each of one or more operations indicated by an input query, and may establish a plan query.

In an embodiment of the disclosure, the LLM 110 may modify the plan query, based on natural language conversations with sub-LMs. The LLM 110 may receive, from one sub-LM, a natural language prompt (or a natural language response) indicating a failure of at least one operation allocated to a sub-module. Based on a natural language prompt indicating at least partial failure of processing according to a plan query, the LLM 110 may modify a performing entity of at least some operations of the plan query to an appropriate another sub-module. Based on the received natural language prompt, the LLM 110 may identify the failure of the at least one operation, and may modify a performing entity of the failed at least one operation within the plan query. In an embodiment of the disclosure, in order to select a new performing entity, the LLM 110 may generate a natural language prompt for inquiring of at least one another sub-module communicating with the LLM 110 whether the failed at least one operation is supported. The LLM 110 may transmit the generated natural language prompt to the at least one another sub-module. Based on a natural language response from the at least one another sub-module, the LLM 110 may select again a performing entity for the failed at least one operation, and may modify the plan query based on the re-selected performing entity.

For example, the plan query established by the LLM 110 may include a feature in which a first operation related to a first blank field is performed by the first sub-module 120. Based on the plan query established by the LLM 110, the first sub-module 120 may attempt to perform the first operation. Based on success in the first operation, the first sub-LM 122 of the first sub-module 120 may generate a natural language response indicating a value corresponding to the first blank query. Based on a failure of the first operation, the first sub-LM 122 may generate a natural language response indicating the failure of the first operation. The first sub-LM 122 may transmit the generated natural language response to the LLM 110. Based on the natural language response from the first sub-LM 122, the LLM 110 may identify the failure of the first operation. Based on the failure of the first operation by the first sub-module 120, the LLM 110 may identify whether the first operation is supported by another sub-module, e.g., the second sub-module 130. For example, as in the method 600 of FIG. 6, the LLM 110 may transmit a natural language inquiry to the second sub-module 130, inquiring whether the first operation is supported. The LLM 110 may receive, from the second sub-LM 132, a natural language response indicating whether the first operation is supported. Based on the natural language response from the second sub-module 130, the LLM 110 may determine whether to modify a performing entity for the first operation in the plan query to the second sub-module 130. For example, based on that the natural language response from the second sub-LM 132 indicates that the first operation is supported by the second sub-module 130, the LLM 110 may determine to modify the performing entity for the first operation in the plan query to the second sub-module 130.

In an embodiment of the disclosure, the natural language response indicating the failure of the first operation may include a reason of the failure of the first operation. For example, the first operation may be failed due to various reasons including a reason in which a precedent condition for the first operation is not satisfied, a reason in which the first operation is no more supported by the first sub-module 120, or a reason in which an error (e.g., software/hardware errors of the TV 12 such as power cut-off, a conflict between applications operating on the TV 12, or freezing of an application) has occurred in a device (e.g., the TV 12) related to the first sub-module 120 while the first operation is performed. The first sub-LM 122 may identify the reason of the failure of the first operation, may generate a natural language response indicating the failure of the first operation with the reason of the failure of the first operation, and may transmit the generated natural language response to the LLM 110. Based on the natural language response from the first sub-LM 122, the LLM 110 may identify the failure of the first operation and the reason of the failure of the first operation. Based on the failure of the first operation and the reason of the failure of the first operation, the LLM 110 may modify the plan query. For example, the LLM 110 may modify the performing entity for the first operation to another performing entity, or may modify the plan query so as to allow a second operation to be performed, the second operation being enabled to achieve a similar goal to the first operation. In order to modify the plan query, the LLM 110 may continue a natural language conversation with the first sub-LM 122 and/or the second sub-LM 132. For example, the LLM 110 may transmit a natural language prompt to inquire of the second sub-LM 132 whether the first operation is supported. The LLM 110 may transmit, to the first sub-LM 122, a natural language prompt for inquiring whether it is possible to perform the second operation instead of the first operation. Based on a natural language response from each sub-module, the LLM 110 may modify the plan query.

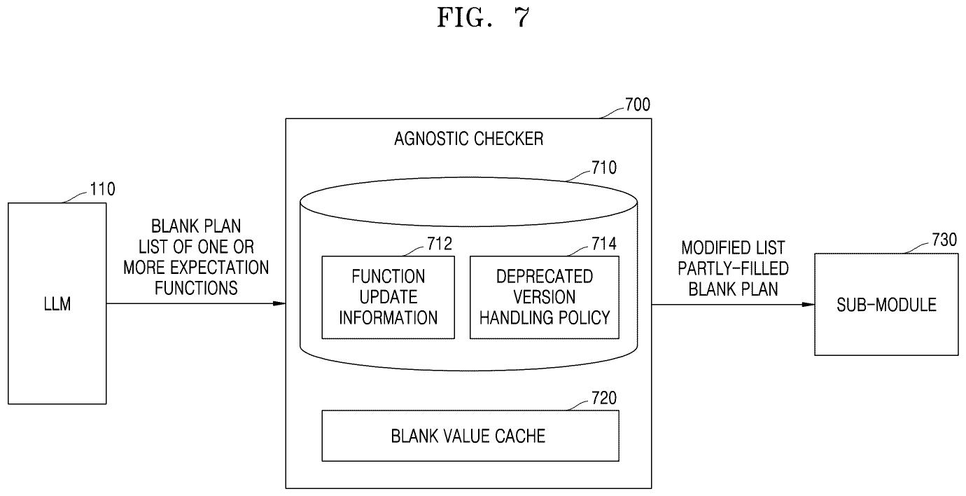

FIG. 7 is a block diagram of an example of an agnostic checker 700, according to an embodiment of the disclosure.

Referring to FIG. 7, the agnostic checker 700 may receive, from the LLM 110, a plan query and a list of one or more expectation functions expected to be performed by a sub-module 730. The agnostic checker 700 may time-agnostically, domain-agnostically, and/or module-agnostically check the plan query and/or the list of expectation functions, which are generated by the LLM 110. As a result of the check, the agnostic checker 700 may provide the sub-module 730 with a list of modified one or more expectation functions and/or a partly-filled (or partly-modified) plan query.

The agnostic checker 700 may include a database 710 and a blank value cache 720. The database 710 may store function update information 712 and a deprecated version handling policy 714. The function update information 712 may indicate functions that are currently supported by the sub-module 730. The function update information 712 may include information indicating the updated specification of the sub-module 730. The function update information 712 may include information indicating changes of functions supported by the sub-module 730. The deprecated version handling policy 714 may include a handling policy of one or more functions that are deprecated or no more supported by the sub-module 730. For example, the deprecated version handling policy may include a policy that indicates to substitute deprecated one or more functions with a third function supported by the sub-module 730.

According to an embodiment of the disclosure, the agnostic checker 700 may periodically or aperiodically obtain a list of functions currently supported by the sub-module 730, the updated specification of the sub-module 730, changes in the specification of the sub-module 730, and/or one or more policies indicating handling with respect to functions that are not supported anymore. The agnostic checker 700 may store the list of functions currently supported by the sub-module 730, the updated specification of the sub-module 730, and/or the changes in the specification of the sub-module 730, as the function update information 712, in the database 710. The agnostic checker 700 may store the one or more policies indicating handling with respect to functions that are not supported anymore, as the deprecated version handling policy 714, in the database 710.

The blank value cache 720 may store one or more values previously filled by the sub-module 730. The sub-module 730 may fill one or more blank queries in a previous plan query from the LLM 110 with actual values, not dummy values. The sub-module 730 may provide one or more filled blank queries to the agnostic checker 700. The agnostic checker 700 may store the one or more filled blank queries from the sub-module 730, in the blank value cache 720.

According to an embodiment of the disclosure, the LLM 110 may transmit, to each sub-module, a part of the plan query and a guide query with a list of one or more expectation functions expected to be executed by each sub-module. The agnostic checker 700 may time-agnostically check the one or more expectation functions from the LLM 110. For example, the agnostic checker 700 may identify whether the one or more expectation functions included in the list are currently supported by the sub-module 730, based on the function update information 712. Based on identifying that a first expectation function among the one or more expectation functions included in the list is not supported by the sub-module 730, the agnostic checker 700 may convert (or change) at least a part of the one or more expectation functions, the part including the first expectation function, into one or more functions supported by the sub-module 730, based on the deprecated version handling policy 714.

The agnostic checker 700 may domain-agnostically check the one or more expectation functions from the LLM 110. For example, the agnostic checker 700 may identify that the LLM 110 has selected a particular expectation function for an inappropriate sub-module, e.g., the sub-module that does not support the particular expectation function. The agnostic checker 700 may notify the LLM 110 that the inappropriate sub-module has been selected. Additionally or alternatively, based on identifying that a second expectation function among the one or more expectation functions included in the list of one or more expectation functions is not supported by the sub-module 730, the agnostic checker 700 may remove the second expectation function from the list.

The agnostic checker 700 may module-agnostically check the plan query from the LLM 110. For example, the agnostic checker 700 may identify whether a corresponding value is stored in the blank value cache 720 with respect to each of one or more blank queries included in the plan query. The agnostic checker 700 may fill blank field(s) included in the plan query, based on a value previously received from the sub-module 730, the value being stored in the blank value cache 720. The agnostic checker 700 may transmit the plan query that is at least partly filled to the sub-module 730.

According to an embodiment of the disclosure, the electronic device 200 may obtain, from the LLM 110, the list of one or more expectation functions expected to be executed by the sub-module 730, based on an input query. The obtained list may be provided to the agnostic checker 700. The agnostic checker 700 may modify the list of one or more expectation functions, at least partly based on the function update information 712 indicating the functions currently supported by the sub-module 730 and the deprecated version handling policy 714 including the handling policy of deprecated one or more functions. The agnostic checker 700 may transmit the modified list of one or more expectation functions to a sub-module.

According to an embodiment of the disclosure, the agnostic checker 700 may identify, based on the function update information 712, whether one or more expectation functions included in the list of one or more expectation functions are supported by the sub-module 730. Based on identifying that a first expectation function among the one or more expectation functions included in the list of one or more expectation functions is not supported by the sub-module 730, the agnostic checker 700 may convert at least some of the one or more expectation functions, the some including the first expectation function, into one or more functions supported by the sub-module 730, based on the deprecated version handling policy 714. Additionally or alternatively, based on identifying that a second expectation function among the one or more expectation functions included in the list of one or more expectation functions is not supported by the sub-module 730, the agnostic checker 700 may remove the second expectation function from the list of one or more expectation functions.

According to an embodiment of the disclosure, the agnostic checker 700 may fill at least one blank field included in the plan query, based on a value previously received from the sub-module 730, the value being stored in the agnostic checker 700. The agnostic checker 700 may transmit the plan query that is at least partly filled to the sub-module 730.

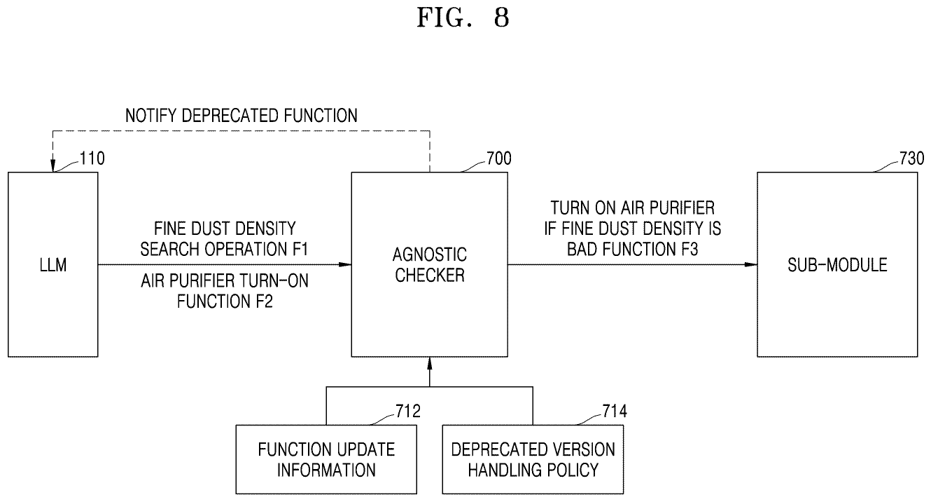

FIG. 8 illustrates an example of an operation for modifying an expectation function, according to an embodiment of the disclosure.

Referring to FIG. 8, the agnostic checker 700 may receive a list of expectation functions from the LLM 110. The list of expectation functions may include a function F1 corresponding to a fine dust density search operation and a function F2 corresponding to an air purifier turn-on operation. The agnostic checker 700 may identify whether functions F1 and F2 are currently supported by the sub-module 730, based on the function update information 712. In an embodiment of the disclosure shown in FIG. 8, the function update information 712 may include information indicating that fine dust density search function F1 is deprecated and function F3 corresponding to an operation ‘Turn on air purifier if fine dust density is bad’ is supported by the sub-module 730. The agnostic checker 700 may identify, based on the function update information 712, that function F1 is no more supported by the sub-module 730.

Based on identifying that function F1 is no more supported by the sub-module 730, the agnostic checker 700 may search for a policy related to function F1 included in the deprecated version handling policy 714. Based on the found policy, the agnostic checker 700 may convert or modify function F1 into other function. For example, the deprecated version handling policy 714 may include a policy indicating to substitute a combination of function F1 and function F2 with function F3. The agnostic checker 700 may search for an aforementioned policy related to F1. Based on the found policy, the agnostic checker 700 may convert the combination of function F1 and function F2 included in the list of one or more functions from the LLM 110 into function F3. Instead of the combination of function F1 and function F2, the agnostic checker 700 may provide function F3 to the sub-module 730.

Additionally or alternatively, the agnostic checker 700 may notify the LLM 110 that function F1 is no more supported by the sub-module 730 or function F1 is deprecated function. Additionally or alternatively, the agnostic checker 700 may provide the LLM 110 with at least a part of the function update information 712 and at least a part of the deprecated version handling policy 714 and may also request the LLM 110 to modify or re-generate a plan query and/or a guide query.

According to an embodiment of the disclosure, the deprecated version handling policy 714 may not include a policy with respect to a particular deprecated function or may include a policy indicating that a function for replacing the particular deprecated function does not exist. Accordingly, the agnostic checker 700 may not convert the particular deprecated function into other function(s), and may remove the particular deprecated function from the list of expectation functions from the LLM 110.

For example, the LLM 110 may receive an input query such as ‘Reduce brightness of all devices in the living room’, and based on the input query, may provide, as expectation function, a function corresponding to a brightness reducing operation to a sub-module related to any one of devices (e.g., TV, lamp, air purifier, etc.) existing in the living room. In this regard, it is assumed that an air purifier among the devices in the living room is recently replaced by a new air purifier. The new air purifier may not provide a feature of adjusting brightness of light included therein. The change of the specification of the new air purifier may be provided to the agnostic checker 700, and the agnostic checker 700 may have stored the change of the specification of the new air purifier as the function update information 712 in the database 710. Also, as the new air purifier does not provide a feature of adjusting brightness of light, a function for replacing a brightness reduction function may not exist. Therefore, the updated deprecated version handling policy 714 additionally including a policy indicating that a function for replacing a brightness reduction function may not exist may be stored in the agnostic checker 700. With respect to a function corresponding to a brightness reduction operation and included in the list from the LLM 110, the agnostic checker 700 may identify, based on the change of the specification of the new air purifier included in the function update information 712, that the function corresponding to the brightness reduction operation is no more supported by a sub-module related to the air purifier. Also, the agnostic checker 700 may identify, based on the deprecated version handling policy 714, that a function for replacing the function corresponding to the brightness reduction operation does not exist. Accordingly, the agnostic checker 700 may remove, from the list, the function corresponding to the brightness reduction operation and included in the list of expectation functions from the LLM 110. The agnostic checker 700 may notify the LLM 110 that the function corresponding to the brightness reduction operation is no more supported by a sub-module related to the air purifier.

According to an embodiment of the disclosure, the updated specification of a device, equipment, or software which is related to the LLM-based system 100 may be periodically or aperiodically provided to the agnostic checker 700. Based on the updated specification, the agnostic checker 700 may independently convert one or more expectation functions selected by the LLM 110 into other function(s) or may discard the one or more expectation functions. The agnostic checker 700 may continually track, monitor, or follow up functions supported by each sub-module. Accordingly, even when the specification of a device, equipment, or software which is related to the LLM-based system 100 is modified, the LLM 110 may not need to be retrained. Therefore, occurrence of hallucination due to excessive retraining may be prevented, and the retraining cost may be reduced.

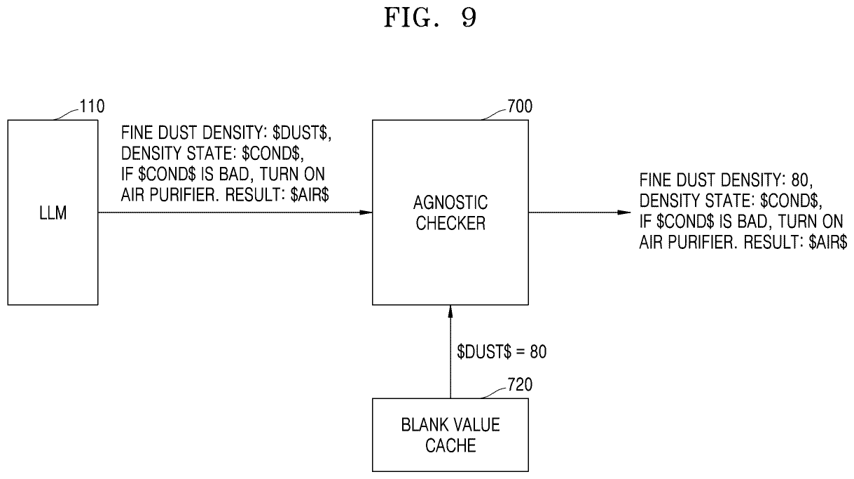

FIG. 9 illustrates an example of an operation for at least partly filling a plan query, according to an embodiment of the disclosure.

Referring to FIG. 9, the agnostic checker 700 may receive a generated plan query from the LLM 110. The agnostic checker 700 may fill one or more blank queries (e.g., first, second, etc.) of the plan query, based on one or more values stored in the blank value cache 720. The agnostic checker 700 may provide the plan query that is at least partly filled to the sub-module 730.

For example, the agnostic checker 700 may receive, from the LLM 110, the plan query such as ‘Fine dust density: ‘$DUST$, Density state: $COND$, If $COND$ is bad, turn on air purifier. Result: $AIR$’. Before the plan query is received, a plan query such as ‘Fine dust density: ‘$DUST$’ established for an input query might have existed, and the sub-module 730 might have transmitted, to the LLM 110, a response indicating that a fine dust density is 80 in the form of {$DUST$: 80} with respect to the plan query. Based on the response of the sub-module 730, the fine dust density value of 80 may have been stored in the blank value cache 720 of the agnostic checker 700. Based on the fine dust density value stored in the blank value cache 720, the agnostic checker 700 may fill a blank field ‘$DUST$’ with ‘80’ included in the plan query. The agnostic checker 700 may provide the modified plan query ‘Fine dust density: 80, Density state: $COND$, If $COND$ is bad, turn on air purifier. Result: $AIR$’ including the filled-blank query ‘$DUST$’ to the sub-module 730. Therefore, the sub-module 730 may sequentially perform operations included in the plan query, without the need to separately obtain a fine dust density value. Accordingly, an operating speed of the sub-module 730 may be improved, and the execution cost of a function of the sub-module 730 may be reduced.

FIG. 10 is a flowchart of an example of an operation of generating a final response, according to an embodiment of the disclosure.

Referring to FIG. 10, operation 350 of FIG. 3 may include operations 1010 and 1020. According to an embodiment of the disclosure, operations 1010 and 1020 may be performed by the electronic device 200 of FIG. 2. However, the disclosure is not limited thereto, and operations 1010 and 1020 may be individually or collectively performed by a random electronic device. The method according to an embodiment of the disclosure is not limited to what is shown in FIG. 10, and may exclude any one of operations shown in FIG. 10 or may further include one or more operations not shown in FIG. 10. In some embodiments of the disclosure, an order of operations 1010 and 1020 may be changed at least in part.

In operation 1010, the electronic device 200 may input a first response to the LLM 110. The first response may include one or more values corresponding to one or more blank queries, generated by using a sub-LM. For example, the first response may include one or more values corresponding to one or more blank queries as Response 1 such as ‘{$TV$: ON}’ of FIG. 1 included in the plan query generated in operation 320.

In operation 1020, based on all blank queries included in the plan query being filled, the electronic device 200 may obtain a final response from the LLM 110. For example, the LLM 110 may fill, replace, or substitute at least one blank query included in the plan query generated in operation 320, with one or more values included in the first response. The LLM 110 may identify whether all blank queries included in the plan query are filled. For example, the LLM 110 may identify whether dummy values of all of the blank queries included in the plan query are replaced with actual values. Based on that the dummy values of all of the blank queries included in the plan query are replaced with actual values, the LLM 110 may identify that all blank queries in the plan query are filled. Otherwise, the LLM 110 may identify that at least one blank query in the plan query is not filled. Based on identifying that all blank queries are filled, the LLM 110 may determine that there is no need to establish an additional plan query. By using the values of the filled blank queries, the LLM 110 may infer whether a goal of an input query has been achieved. Based on a result of the inference, the LLM 110 may generate the final response.

For example, in an embodiment of FIG. 1, ‘Response 1’ and ‘Response 2’ may be input to the LLM 110. Response 1 may include a value ‘ON’ corresponding to the blank field ‘$TV$. Response 2 may include a value ‘80’ corresponding to the blank field ‘$DUST$, a value ‘Bad’ indicating the blank field ‘$COND$, and a value ‘ON’ corresponding to the blank field ‘$AIR$. By using the values included in Response 1 and Response 2, the LLM 110 may fill the plan query including ‘Plan 1’ and ‘Plan 2’. For example, the plan query filled by using the values included in Response 1 and Response 2 may correspond to ‘Turning on TV. Result: ON. Fine dust density: 80, Density state: Bad, If Bad is bad, turn on air purifier. Result: ON’. Based on the filled plan query, the LLM 110 may perform inference to generate the final response. For example, based on a result value ‘ON’ for turning on TV, ‘Bad’ for a density state value, and a result ‘ON’ for turning on air purifier, the LLM 110 may infer that a TV is turned on, and an air purifier is turned on because a fine dust density state is bad. Accordingly, the LLM 110 may generate the final response 114 such as ‘TV is turned on. Air purifier is turned on because fine dust density is bad as 80’, based on the filled plan query.

FIG. 11 is a flowchart of an example of an operation of generating a final response, according to an embodiment of the disclosure.

Referring to FIG. 11, operation 350 of FIG. 3 may include operations 1110, 1120, 1130, 1140, and 1150. According to an embodiment of the disclosure, operations 1110, 1120, 1130, 1140, and 1150 may be performed by the electronic device 200 of FIG. 2. However, the disclosure is not limited thereto, and operations 1110, 1120, 1130, 1140, and 1150 may be individually or collectively performed by a random electronic device. Operation 350 according to an embodiment of the disclosure is not limited to what is shown in FIG. 11, and may exclude any one of operations shown in FIG. 11 or may further include one or more operations not shown in FIG. 11. In some embodiments of the disclosure, an order of operations 1110, 1120, 1130, 1140, and 1150 may be changed at least in part.

In operation 1110, the electronic device 200 may input a first response to the LLM 110. The first response may include one or more values corresponding to one or more blank queries, generated by using a sub-LM. For example, the first response may include one or more values corresponding to one or more blank queries as Response 1 such as ‘{$TV$: ON}’ of FIG. 1 included in the plan query generated in operation 320.

In operation 1120, based on a second blank query included in the plan query not being filled, the electronic device 200 may obtain an additional plan including the second blank field and an additional guide query from the LLM 110. For example, the LLM 110 may fill at least one blank field included in the plan query generated in operation 320, by using one or more values included in the first response. The LLM 110 may identify whether all blank queries included in the plan query are filled. Based on identifying that the second blank field is not filled, the LLM 110 may determine to generate an additional plan query to fill the second blank field. Accordingly, the LLM 110 may generate, based on an input query, an additional plan including the second blank field and an additional guide query. The additional guide query may be generated based on a part of the input query, the part being related to the second blank field.

In operation 1130, the electronic device 200 may transmit, to a corresponding sub-module, a request for returning a value corresponding to the second blank field or blank query (e.g., first blank query, second blank query, etc.), the additional plan, and the additional guide query. In operation 1140, the electronic device 200 may receive, from the corresponding sub-module, an additional response including the value corresponding to the second blank query. In operation 1150, the electronic device 200 may obtain a final response based on the additional response, by using the LLM 110. For example, the LLM 110 may fill the second blank field included in the additional plan query generated in operation 1120, by using the aforementioned value included in the additional response. The LLM 110 may identify whether all blank queries included in the additional plan query are filled. Based on identifying that all blank queries are filled, the LLM 110 may determine that there is no need to additionally establish a plan query. By using the values of the filled blank queries, the LLM 110 may infer whether a goal of the input query has been achieved. Based on a result of the inference, the LLM 110 may generate the final response.

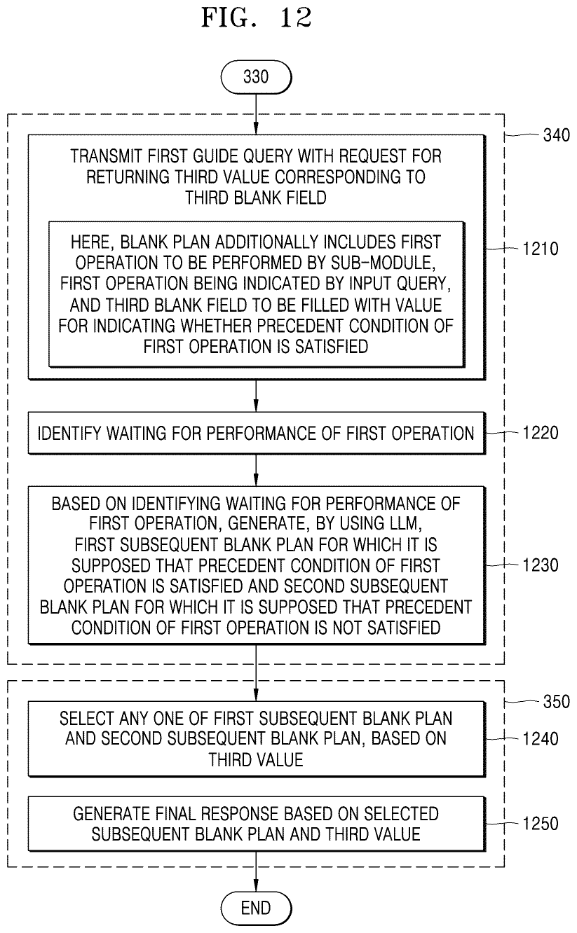

FIG. 12 is a flowchart of an example of an operation of generating a final response by using a subsequent plan query, according to an embodiment of the disclosure.

Referring to FIG. 12, operation 340 of FIG. 3 may include operations 1210, 1220, and 1230. Operation 350 of FIG. 3 may include operations 1240 and 1250. According to an embodiment of the disclosure, operations 1210, 1220, 1230, 1240, and 1250 may be performed by the electronic device 200 of FIG. 2. However, the disclosure is not limited thereto, and operations 1210, 1220, 1230, 1240, and 1250 may be individually or collectively performed by a random electronic device. Operation 340 and/or operation 350 according to an embodiment of the disclosure is not limited to what is shown in FIG. 12, and may exclude any one of operations shown in FIG. 12 or may further include one or more operations not shown in FIG. 12. In some embodiments of the disclosure, an order of operations 1210, 1220, 1230, 1240, and 1250 may be changed at least in part.

In operation 1210, the electronic device 200 may transmit, by using the LLM 110, to a sub-module, a first guide query with a request for returning a third value corresponding to a third blank query. The plan query may additionally include a first operation to be performed by the sub-module, the first operation being indicated by the input query, and the third blank field to be filled with a value for indicating whether a precedent condition of the first operation is satisfied. For example, the LLM 110 may identify whether a random operation is executed is changed according to a particular precedent condition. Before an operation for which a precedent condition is present is executed, the LLM 110 may establish the plan query including the third blank field so as to identify whether the precedent condition is satisfied.

In operation 1220, the electronic device 200 may identify the waiting for performance of the first operation. For example, the electronic device 200 may identify whether an additional time is required to perform operations (e.g., processing, by the sub-module, of the plan query and receiving of a response from the sub-module in operation 1210) to identify whether the precedent condition of the first operation is satisfied. Based on identifying that the additional time is required, the electronic device 200 may identify the waiting for performance of the first operation.

In operation 1230, based on identifying the waiting for performance of the first operation, the electronic device 200 may generate, by using the LLM 110, a first subsequent plan query for which it is supposed that the precedent condition of the first operation is satisfied. Based on identifying the waiting for performance of the first operation, the electronic device 200 may generate, by using the LLM 110, a second subsequent plan query for which it is supposed that the precedent condition of the first operation is not satisfied.

In operation 1240, the electronic device 200 may receive the first response additionally including the third value, and may select any one of the first subsequent plan query and the second subsequent plan query, based on the third value included in the first response. For example, the third value may indicate that the precedent condition of the first operation is satisfied. The LLM 110 executed on the electronic device 200 may receive the first response additionally including the third value. Based on the third value, the LLM 110 may identify that the precedent condition of the first operation is satisfied. Based on identifying that the precedent condition of the first operation is satisfied, the LLM 110 may select the first subsequent plan query generated by supposing that the precedent condition of the first operation is satisfied. Based on the third value indicating that the precedent condition of the first operation is not satisfied, the LLM 110 may identify that the precedent condition of the first operation is not satisfied. Based on identifying that the precedent condition of the first operation is not satisfied, the LLM 110 may select the second subsequent plan query generated by supposing that the precedent condition of the first operation is not satisfied.

In operation 1250, the electronic device 200 may generate a final response based on the selected subsequent plan query and the third value. For example, the LLM 110 executed by the electronic device 200 may fill blank field(s) included in the selected subsequent plan query, by using one or more values included in the first response. Based on a not-filled blank field being present in the selected subsequent plan query, the LLM 110 may generate a final response based on the selected subsequent plan query. Based on the not-filled blank field being present in the selected subsequent plan query, the LLM 110 executed by the electronic device 200 may generate, based on the input query, an additional guide query for filling the not-filled blank query. The LLM 110 may transmit the selected subsequent plan query and the additional guide query to an appropriate sub-module. The LLM 110 may receive a value corresponding to the not-filled blank field from the sub-module, and may generate the final response by using the received value.

According to an embodiment of the disclosure, the electronic device 200 may receive the first response additionally including a value indicating a failure of a second operation. For example, the LLM 110 executed by the electronic device 200 may discard the first subsequent plan query and the second subsequent plan query, based on a value indicating a failure of the first operation. Based on the value indicating the failure of the first operation, for example, the LLM 110 executed by the electronic device 200 may generate the final response including information indicating the failure of the first operation.

For example, with respect to an input query such as ‘Turn on an air purifier if fine dust density is bad, and if the air purifier is turned on, turn on an air conditioner as well’, the LLM 110 may identify that a precedent condition for ‘Turning on air conditioner’ is ‘Air purifier is turned on’. The LLM 110 may identify that it takes time to check a state of the air purifier which is the precedent condition. Accordingly, the LLM 110 may determine the precedent condition as a condition branch. The LLM 110 may decompose the input query, based on the condition branch. The LLM 110 may establish a first plan query such as ‘Fine dust density: $DUST$, Density state: $COND$, If $COND$ is bad, turn on air purifier. Result: $AIR$’, based on a front part ‘Turn on an air purifier if fine dust density is bad’ of the decomposed input query, and may provide the first plan query to a sub-module related to the air purifier.

While one or more operations based on the first plan query are performed by the sub-module related to the air purifier, the LLM 110 may establish one or more subsequent queries (e.g., subsequent plan queries), based on the precedent condition. The LLM 110 may represent, as a blank query a part for which a value has to be obtained from a sub-module being irrelevant to ‘Turning on air conditioner’, e.g., the sub-module related to the air purifier. The LLM 110 may generate in advance one or more subsequent queries (e.g., subsequent plan query) by considering various branches such as a branch in which the precedent condition is satisfied, a branch in which the precedent condition is not satisfied, a branch in which an operation of ‘turning on air purifier’ fails, and/or a branch in which an operation of ‘turning on air conditioner’ fails. According to an embodiment of the disclosure, the LLM 110 may generate up to four subsequent queries (e.g., subsequent plan query). For example, examples of the subsequent plan query are as below:
Case 1: Fine dust density: $DUST$, Density state: Good→END
Case 2: Fine dust density: $DUST$, Density state: Bad→Air purifier is not turned on due to a problem in its state→Air conditioner is not turned on→END
Case 3: Fine dust density: $DUST$, Density state: Bad→Air purifier is turned on→Air conditioner is not turned on due to a problem in its state→END
Case 4: Fine dust density: $DUST$, Density state: Bad→Air purifier is turned on→Air conditioner is turned on→END

Afterward, based on a response to the first plan query which is received from the sub-module related to the air purifier, the LLM 110 may select any one of the subsequent queries (e.g., plan query). For example, based on receiving, from the sub-module, a response indicating ‘Good’ as a density state with ‘30’ as fine dust density, the electronic device 200 may select the subsequent plan query of Case 1. Based on receiving, from the sub-module, a response indicating ‘Bad’ as a density state with ‘80’ as fine dust density and indicating that it is not possible to turn on the air purifier, the electronic device 200 may select the subsequent plan query of Case 2. Based on the response to the first plan query, the electronic device 200 may fill blank queries for which values have to be obtained from the sub-module related to the air purifier. For example, the LLM 110 may fill the blank query ‘$DUST’ by using a fine dust density value included in the response received from the sub-module. Based on the filled subsequent plan query, the electronic device 200 may generate the final response by using the LLM 110.

Based on receiving a response indicating a failure in execution of an operation from the sub-module related to the air purifier or a sub-module related to the air conditioner, the LLM 110 may discard the pre-established subsequent plan query) (s). The LLM 110 may perform generation of a response corresponding to the failure. For example, the LLM 110 may receive, from the sub-module related to the air purifier, a response indicating that it fails to turn on the air purifier due to a problem in the state of the air purifier. Accordingly, the LLM 110 may select the subsequent plan query corresponding to Case 2, and may discard remaining subsequent plan query). Afterward, the LLM 110 may generate a final response indicating that it fails to turn on the air purifier due to a problem in the state of the air purifier and the air conditional is not turned on.

Even when operation execution by a sub-module fails, there is a need to generate a plan corresponding to the failure. Therefore, the LLM 110 may previously generate a plurality of subsequent queries (e.g., plan query) based on a condition branch, and may at least partly pre-generate a final response for each plan. For example, the LLM 110 may generate a final response according to each subsequent plan query in a batch generation procedure, previously before a part related to ‘Turning on air conditioner’ that is a subsequent operation. As a part of a response according to a plan is previously generated, a response indicating a failure may be rapidly generated. For example, with respect to the plan query of Case 1 above, the LLM 110 may previously generate a final response (e.g., As fine dust density is as good as $DUST$, air purifier and air conditioner are not turned on) corresponding to ‘END’. With respect to the plan query of Case 2, the LLM 110 may previously generate a partial final response (e.g., Although fine dust density is as bad as $DUST$, air purifier is not turned on due to a problem in a state of air purifier) corresponding to ‘Air conditioner is not turned on due to a problem in its state’. With respect to the queries (e.g., plan query, etc.) of Cases 3 and 4, the LLM 110 may previously generate a partial final response (e.g., As fine dust density is as bad as $DUST$, air purifier is turned on) corresponding to ‘Turning on air purifier’. Afterward, the LLM 110 may select any one subsequent plan query, based on a response from the sub-module related to the air purifier and/or the sub-module related to the air conditioner, and may generate an entire final response by using the pre-generated final response.

According to an embodiment of the disclosure, the processor 210 of the electronic device 200 may be configured to fill a plan query and/or one or more blank queries included in a subsequent plan query, based on response(s) from sub-module(s). The processor 210 may be configured to generate a final response by using the LLM 110, based on the plan query and/or the subsequent plan query which is filled. The processor 210 may be configured to select any one subsequent plan query generated by the LLM 110 and to guide (or induce) the LLM 110 to select the selected subsequent plan query.

For example, based on receiving a response indicating a failure in execution of an operation from the sub-module related to the air purifier or the sub-module related to the air conditioner, the processor 210 of the electronic device 200 may select a subsequent plan query, based on a response from a sub-module and a predefined rule. The processor 210 may guide the LLM 110 to select the subsequent plan query selected by the processor 210. For each of subsequent queries (e.g., plan query, etc.), the LLM 110 may previously define a rule for selecting a corresponding plan query when each subsequent plan query is generated. For example, the LLM 110 may determine a rule so that Case 1 is to be selected when an actual value of fine dust density is equal to or greater than a predefined threshold. The LLM 110 may determine a rule so that Cases 2 to 4 are to be selected when a value of a blank field indicating a state of an air purifier and/or a value of a blank field indicating a state of an air conditioner, which is included in a response from a sub-module related to the air purifier or a sub-module related to the air conditioner, is any one of predefined values. The predefined rule for each subsequent plan query may be controlled by the processor 210.

According to an embodiment of the disclosure, the LLM 110 may previously generate one or more subsequent queries (e.g., plan query, etc.) while waiting for a result of execution by any one sub-module. Accordingly, a time required to generate a final response by using the LLM 110 may be reduced.

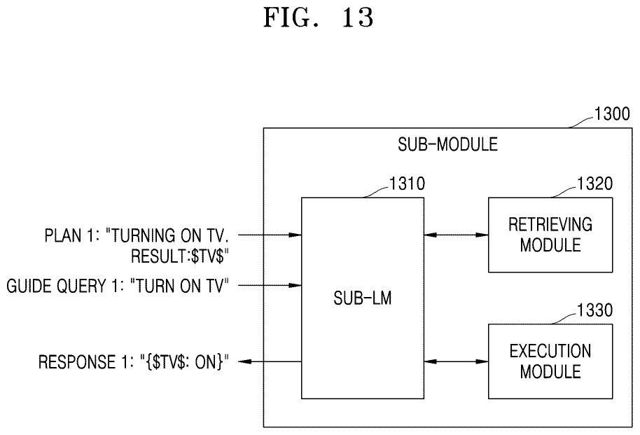

FIG. 13 is a block diagram of an example of a sub-module 1300 according to an embodiment of the disclosure.

Referring to FIG. 13, the sub-module 1300 may include a sub-LM 1310, a retrieving module 1320, and an execution module 1330. FIG. 13 shows only essential elements for describing features and/or operations of the sub-module 1300, and elements included in the sub-module 1300 are not limited to what is shown in FIG. 13. The configuration of the sub-module 1300 shown in FIG. 13 is exemplary, and an example of the sub-module 1300 for performing an embodiment of the disclosure is not limited to the configuration shown in FIG. 13. In an embodiment of the disclosure, one or more configurations shown in FIG. 13 may be deleted or changed, or a configuration not shown in FIG. 13 may be added to the sub-module 1300.

The sub-LM 1310 may receive a plan query and guide query from the LLM 110. The sub-LM 1310 may rewrite the guide query by considering the specification of the retrieving module 1320, based on the received plan query. The sub-LM 1310 may provide the rewritten guide query to the retrieving module 1320. The sub-LM 1310 may obtain one or more retrieved functions from the retrieving module 1320. The sub-LM 1310 may provide at least one of the retrieved functions to the execution module 1330. For example, the sub-LM 1310 may select, among the retrieved functions, at least one function appropriate for performing operations indicated by an input query, and may provide the selected at least one function to the execution module 1330. The sub-LM 1310 may receive a result of executing the at least one function from the execution module 1330. Based on the execution result, the sub-LM 1310 may generate a response to the plan query and the guide query, and may transmit the generated response to the LLM 110.

According to an embodiment of the disclosure, the sub-module 1300 may receive, from the LLM 110, the plan query and the guide query with a request for returning one or more values corresponding to one or more blank queries. Based on the plan query and the guide query, the sub-LM 1310 may generate the response including one or more values to be returned. The sub-LM 1310 may transmit the generated response to the LLM 110.

The retrieving module 1320 may obtain a rewritten query from the sub-LM 1310. The retrieving module 1320 may store functions executable by the sub-module 1300. The retrieving module 1320 may retrieve one or more functions that are executable by the sub-module 1300, based on the rewritten query. According to an embodiment of the disclosure, the retrieving module 1320 may retrieve top-k functions that are most appropriate for the rewritten query, and may provide the sub-LM 1310 with a list in which the retrieved functions are sequentially listed (where, k is a predefined natural number).

According to an embodiment of the disclosure, the sub-LM 1310 may receive, from the LLM 110 or the agnostic checker 700, a list of one or more expectation functions expected to be performed by the execution module 1330. The sub-LM 1310 may rewrite a query by considering the one or more expectation functions. The sub-LM 1310 may select at least one of the one or more functions retrieved by the retrieving module 1320, in consideration of the one or more expectation functions.

According to an embodiment of the disclosure, the LLM-based system 100 may include one or more sub-modules, and the one or more sub-modules may respectively include retrieving modules. When different sub-modules have the similar feature and/or functions having the similar description exist in one index, function retrieving performance may deteriorate. For example, a function ‘Turn on TV’ and a function ‘Turn on air conditioner’ may have the same description as ‘Turn on device’, and thus, when the two functions exist in one index, the function ‘Turn on TV’ may be retrieved for an air conditioner. As sub-modules may respectively include retrieving modules, it is possible to prevent that inappropriate functions having the similar feature and/or description are retrieved.

The execution module 1330 may execute at least one function selected by the sub-LM 1310. By executing the at least one function, the execution module 1330 may control a device, equipment, or software related to the sub-module 1300 to perform particular operation(s). The execution module 1330 may provide the sub-LM 1310 with a value indicating a result of executing the at least one function. According to an embodiment of the disclosure, the execution module 1330 may return, to the sub-LM 1310, a value indicating the result of executing the at least one function by using a predefined uniform template. Accordingly, the sub-LM 1310 may easily generate a response to be provided to the LLM 110.

According to an embodiment of the disclosure, the execution module 1330 may be shared between a plurality of sub-modules. For example, when the number of features supported for one device exceeds a threshold number, a plurality of sub-modules may be configured for one device, the features may be distributed between the plurality of sub-modules, and each sub-module may handle a set of separate features that do not overlap each other. Each of the plurality of sub-modules may include one sub-LM and one retrieving module. In order to actually execute a function, the plurality of sub-modules may share one execution module.

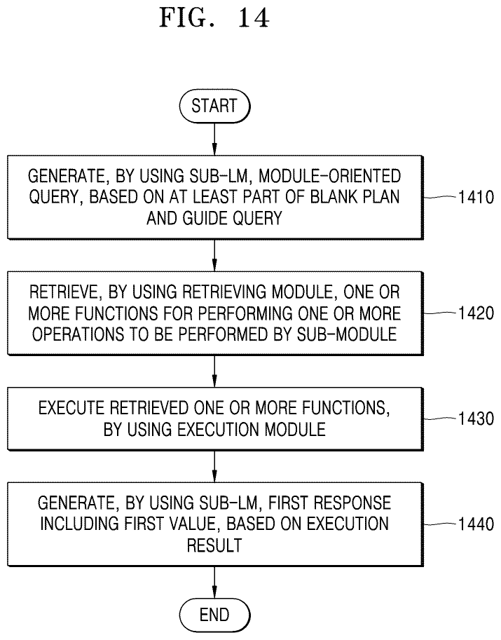

FIG. 14 is a flowchart of an example of a method 1400 of generating a response by using the sub-LM 1310, according to an embodiment of the disclosure.

Referring to FIG. 14, the method 1400 may include operations 1410, 1420, 1430, and 1440. According to an embodiment of the disclosure, the method 1400 may be performed by the sub-module 1300 of FIG. 13. However, the disclosure is not limited thereto, and operations 1410, 1420, 1430, and 1440 may be individually or collectively performed by a random electronic device. The method according to an embodiment of the disclosure is not limited to what is shown in FIG. 14, and may exclude any one of operations shown in FIG. 14 or may further include one or more operations not shown in FIG. 14. In some embodiments of the disclosure, an order of operations 1410, 1420, 1430, and 1440 may be changed at least in part.

In operation 1410, the sub-module 1300 may generate, by using the sub-LM 1310, a module-oriented query, based on at least a part of a plan query, etc.) and a guide query. The sub-LM 1310 may rewrite the guide query to the module-oriented query adapted for (or retriever-aligned with) the retrieving module 1320, based on at least a part of the plan query, etc.) and the guide query. For example, the sub-LM 1310 may rewrite the guide query according to the format or the template supported by the retrieving module 1320.

In operation 1420, the sub-module 1300 may retrieve, by using the retrieving module 1320, one or more functions for performing one or more operations to be performed by the sub-module 1300. For example, in operation 1410, the sub-LM 1310 may provide the generated module-oriented query to the retrieving module 1320. The retrieving module 1320 may retrieve one or more functions, based on the module-oriented query. The retrieving module 1320 may provide the retrieved one or more functions to the sub-LM 1310.

In operation 1430, the sub-module 1300 may execute the retrieved one or more functions, by using the execution module 1330. For example, the sub-LM 1310 may obtain the retrieved one or more functions from the retrieving module 1320. The sub-LM 1310 may select at least one of the retrieved functions, and may provide the selected at least one function to the execution module 1330. The execution module 1330 may execute the at least one function selected by the sub-LM 1310. The execution module 1330 may return a value indicating a result of executing the at least one function to the sub-LM 1310.

In operation 1440, the sub-module 1300 may generate a first response including a first value, based on the execution result, by using the sub-LM 1310. For example, the sub-LM 1310 may generate the first response including the first value, based on the value indicating the result of executing the at least one function, the value being returned from the execution module 1330. The first value may include the value indicating the result of executing the at least one function, the value being returned from the execution module 1330. According to an embodiment of the disclosure, the sub-module 1300 may receive, from the LLM 110, the plan query and the guide query with a request for returning one or more values corresponding to one or more blank queries. The first value may be one of the one or more values corresponding to the one or more blank queries.

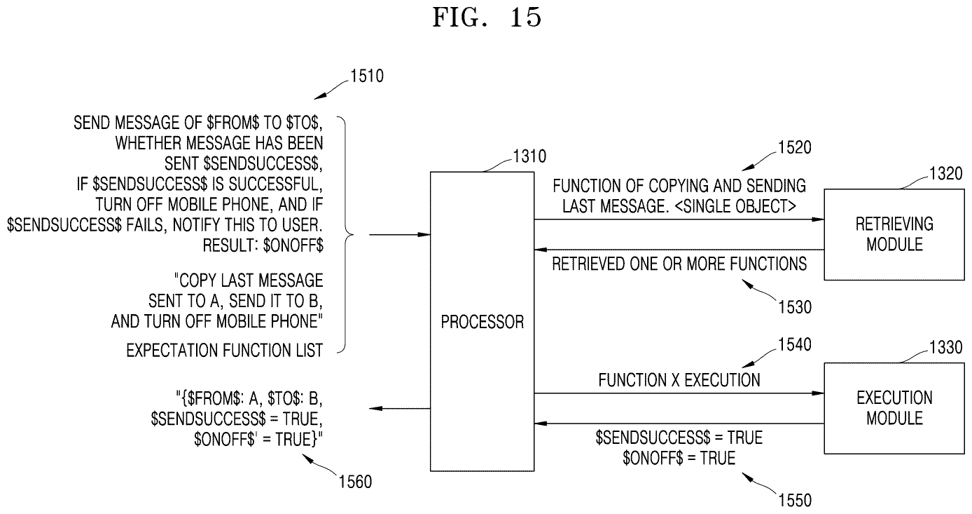

FIG. 15 illustrates an example of operations for generating a response by using the sub-LM 1310, according to an embodiment of the disclosure.

Referring to FIG. 15, the sub-module 1300 may perform operations 1510, 1520, 1530, 1540, 1550, and 1560. However, the disclosure is not limited thereto, and operations 1510, 1520, 1530, 1540, 1550, and 1560 may be individually or collectively performed by a random electronic device. The method according to an embodiment of the disclosure is not limited to what is shown in FIG. 15, and may exclude any one of operations shown in FIG. 15 or may further include one or more operations not shown in FIG. 15. In some embodiments of the disclosure, an order of operations 1510, 1520, 1530, 1540, 1550, and 1560 may be changed at least in part.

The sub-module 1300 may receive, from the LLM 110, a plan query, a guide query, and an expectation function list (operation 1510). For example, the sub-module 1300 may receive, from the LLM 110, the plan query such as ‘Send message of $FROM$ to $TO$, Whether message has been sent $SendSuccess$, If $SendSuccess$ is successful, turn off mobile phone, and if $SendSuccess$ fails, notify this to user. Result: $ONOFF$’. The sub-module 1300 may receive, from the LLM 110, the guide query such as ‘Copy last message sent to A, send it to B, and turn off mobile phone’. The sub-module 1300 may receive, from the LLM 110, the expectation function list including one or more expectation functions. Additionally or alternatively, the sub-module 1300 may receive, from the LLM 110, a request for returning values corresponding to blank queries ‘$FROM$’, ‘$TO$’, ‘$SendSuccess$’, and ‘$ONOFF$’ which are included in the plan query.

The sub-module 1300 may rewrite the guide query to a module-oriented query. The guide query received from the LLM 110 may be a natural language-type query, thereby decreasing a retrieval efficiency of the retrieving module 1320. The sub-LM 1310 may rewrite the guide query by considering the specification of the retrieving module 1320, based on the plan query, the guide query, and/or the expectation function list. For example, the sub-LM 1310 may rewrite the guide query so as to allow the one or more expectation functions included in the expectation function list to be retrieved, based on the plan query and/or the guide query. The sub-LM 1310 may rewrite the guide query by considering a query format supported by the retrieving module 1320. For example, the retrieving module 1320 may support a function condition expressed using a particular format such as ‘<>’. The expectation function list may include a function corresponding to ‘Feature of copying and sending message’. Accordingly, the sub-LM 1310 may rewrite the guide query to the module-oriented query such as ‘Feature of copying and sending last message. <single object>’. The sub-LM 1310 may transmit the rewritten module-oriented query to the retrieving module 1320 (operation 1520).

According to an embodiment of the disclosure, the sub-LM 1310 may be trained to rewrite a given guide query to a query adapted for (or retriever-aligned with) the retrieving module 1320. In order to retrieve not-deprecated (or currently supported), recent, and valid functions, the sub-LM 1310 may be trained to rewrite the module-oriented query, based on the plan query, the guide query, and/or the expectation function list received from the LLM 110. For example, it is assumed that the specification of the sub-module 1300 is changed to internally use the format such as ‘function by <>’. The sub-LM 1310 may be trained on the changed specification of the sub-module 1300, and may be trained to rewrite a guide query to be adapted for (or to be aligned with) the changed specification. Accordingly, the sub-LM 1310 may rewrite a guide query such as ‘If fine dust density is bad, turn on air purifier’ by using the format and the language as ‘TURN_ON by <Fine dust density Bad >’ which is supported in the sub-module 1300.

The retrieving module 1320 may retrieve one or more queries, based on the module-oriented query. The retrieving module 1320 may transmit the retrieved one or more functions to the sub-LM 1310 (operation 1530). The sub-LM 1310 may select at least one of the retrieved one or more functions, based on the plan query, the guide query, and/or the expectation function list. The sub-LM 1310 may transmit the selected at least one function (e.g., ‘function X’) to the execution module 1330 (operation 1540).

The execution module 1330 may execute the at least one function transmitted by the sub-LM 1310. The execution module 1330 may transmit a result of executing the function to the sub-LM 1310 (operation 1550). For example, based on the success in message transmission, the execution module 1330 may return a value ‘true’ corresponding to the blank field ‘$SendSuccess$’ to the sub-LM 1310. Based on the mobile phone being turned off, the execution module 1330 may return a value ‘true’ corresponding to the blank field ‘$ONOFF$’ to the sub-LM 1310.

Based on one or more result values received from the execution module 1330, the sub-LM 1310 may generate a response to be returned to the LLM 110. For example, the sub-LM 1310 may determine values respectively corresponding to blank queries, in response to a request for returning values corresponding to the blank queries ‘$FROM$’, ‘$TO$’, ‘$SendSuccess$’, and ‘$ONOFF$’ which are included in the plan query from the LLM 110. Based on the guide query, the sub-LM 1310 may determine a value corresponding to the blank field ‘$FROM$’ to be ‘A’, and may determine a value corresponding to the blank field ‘$TO$’ to be ‘B’. Based on the result value from the execution module 1330, the sub-LM 1310 may determine a value corresponding to the blank field ‘$SendSuccess$’ to be ‘true’, and may determine a value corresponding to the blank field ‘$ONOFF$’ to be ‘true’. Based on the determined values, the sub-LM 1310 may generate the response, and may transmit the generated response to the LLM 110 (operation 1560).

According to an embodiment of the disclosure, the sub-LM 1310 may be trained to fill one or more blank queries and to generate a response in a predefined format. For example, the sub-LM 1310 may be trained to generate a response in a JavaScript Object Notation (JSON) format, based on values corresponding to the blank queries. According to an embodiment of the disclosure, the sub-LM 1310 may be obtained by fine tuning a pre-trained LM by using appropriate datasets.

For example, the sub-LM 1310 may be trained by using a dataset including a user query, a plan query for the given query, a guide query to be transmitted to the sub-module 1300 based on the given query, a filled plan, and a return response. The dataset may include: a data sample including at least one of an example input query, a plan query established for a history example input query of an input query, a guide query for the sub-module 1300, a plan query in which blank queries related to the sub-module 1300 are filled, or an example response to be returned from the sub-module 1300 to the LLM 110. For example, the data sample may include: at least one of the example input query such as ‘If fine dust density is bad, turn on air purifier’, one or more queries received before the example input query, the plan query such as ‘Turn on TV. Result: $TV$, Turn on air conditioner. Result: $AC$, Fine dust density: $DUST$, Density state: $DENSITY$ Air purifier: $COND$($AIR$→ON, Else→OFF)’, the guide query such as ‘If fine dust density is bad, turn on air purifier’ and/or ‘Search for fine dust density. Turn on air purifier’ for the sub-module 1300, the plan query in which parts (e.g., blank queries related to an air purifier) such as ‘Turn on TV. Result: $TV$, Turn on air conditioner. Result: $AC$, Fine dust density: 80, Density state: Bad, Air purifier: Turned on’ which are related to the sub-module 1300 are filled, or the example response such as ‘{$DUST$: 80, $DENSITY$: Bad, $COND$( . . . ): Turned on}’. By training the sub-LM 1310 by using a data sample including an entire plan query and a plan query in which only blank queries that have to be filled by the sub-module 1300, the sub-LM 1310 may recognize the entire plan, and may learn operations to be processed by the sub-module 1300. Also, the sub-LM 1310 may learn blank queries that it has to fill in the entire plan.

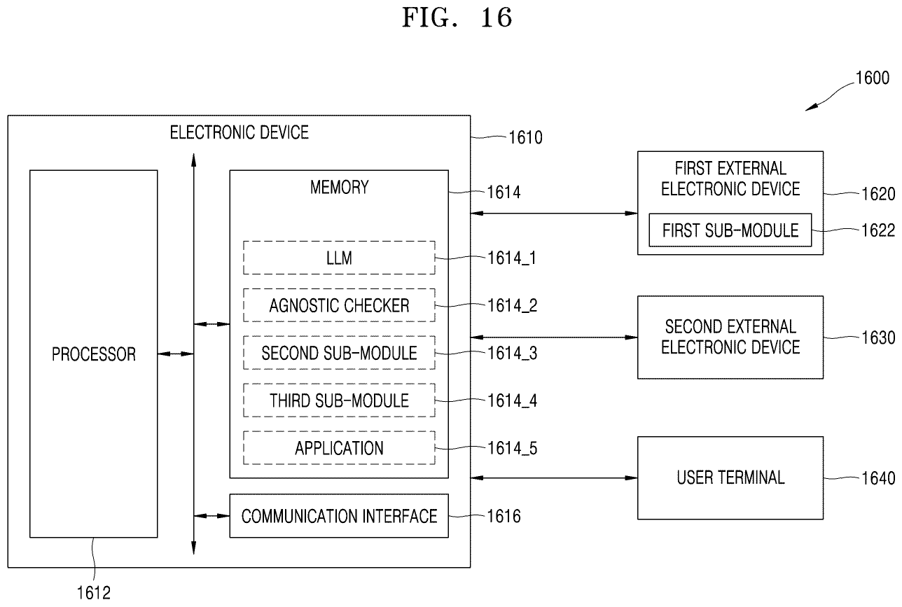

FIG. 16 is a block diagram of an example of an LLM-based system 1600 according to an embodiment of the disclosure.

Referring to FIG. 16, the LLM-based system 1600 may include an electronic device 1610, a first external electronic device 1620, a second external electronic device 1630, and a user terminal 1640. FIG. 16 illustrates only essential elements for describing functions and/or operations of the electronic device 1610, and elements included in the LLM-based system 1600 are not limited to what are shown in FIG. 16. The configuration of the LLM-based system 1600 shown in FIG. 16 is exemplary, and an example of the LLM-based system 1600 which performs an embodiment of the disclosure is not limited to the configuration shown in FIG. 16. In an embodiment of the disclosure, one or more configurations shown in FIG. 16 may be deleted or changed, or a configuration not shown in FIG. 16 may be added to the LLM-based system 1600.

The electronic device 1610 may include a processor 1612, memory 1614, and a communication interface 1616. According to an embodiment of the disclosure, the electronic device 1610 may be referred to as a server configured to execute an LLM 1614_1. The processor 1612 may execute one or more instructions or one or more program codes stored in the memory 1614. For example, the processor 1612 may execute the LLM 1614_1 stored in the memory 1614. The processor 1612 may include a hardware element that performs arithmetic, logic, and input and output operations. Referring to FIG. 16, the processor 1612 is shown as one element, but the disclosure is not limited thereto. In an embodiment of the disclosure, the processor 1612 may include one or more elements.

The processor 1612 may include various types of processing circuitry and/or a plurality of processors. The processor 1612 may be implemented, for example, a general-purpose processor such as a CPU, an AP, a DSP, or the like, a graphics-dedicated processor such as a GPU or a VPU, or an AI-dedicated processor such as a NPU. The processor 1612 may control input data to be processed, according to predefined operating rules or an AI model (e.g., the LLM 1614_1). Alternatively, when the processor 1612 is the AI-dedicated processor, the AI-dedicated processor may be designed in a hardware structure specialized for processing a particular AI model.

The memory 1614 may store instructions, a data structure, and program code, which are readable by the processor 1612. For example, the memory 1614 may store (or load) an LLM 1614_1, an agnostic checker 1614_2, a second sub-module 1614_3, a third sub-module 1614_4, and/or an application 1614_5, which is readable (or executable) by the processor 1612. In an embodiment of the disclosure, the memory 1614 may store instructions that, when executed by the processor 1612 individually or collectively (e.g., collectively by a plurality of processors), cause the electronic device 1610 to perform at least some of operations described in the disclosure. For example, the processor 1612 may execute instructions or codes stored in the memory 1614 to perform at least some of operations of the electronic device 200 described in the disclosure. Elements stored in the memory 1614 are for convenience of descriptions, and the disclosure is not limited thereto.

The memory 1614 may include a flash memory, a hard disk, a multimedia card micro type memory, or a card-type memory. The memory 1614 may include a non-volatile memory (or storage medium) including at least one of ROM, EEPROM, PROM, magnetic memory, magnetic disk, or optical disk, and/or a volatile memory (or storage medium) such as DRAM or SRAM.

According to an embodiment of the disclosure, the memory 1614 may store one or more instructions or program codes for executing the LLM 1614_1. The LLM 1614_1 may operate and be implemented in a similar manner to the LLM 110 described with reference to FIGS. 1 to 15. For example, the memory 1614 may store one or more instructions and/or program codes for causing the electronic device 1610 to generate the final response 114 from the input query 112 of FIG. 1 by using the LLM 1614_1. Elements stored in the c are for convenience of descriptions, and the disclosure is not limited thereto.

According to an embodiment of the disclosure, the memory 1614 may store one or more instructions or program codes for executing the agnostic checker 1614_2. The agnostic checker 1614_2 may operate and be implemented in a similar manner to the agnostic checker 700 described with reference to FIGS. 7 to 9. For example, the memory 1614 may store one or more instructions and/or program codes for causing the electronic device 1610 to modify an expectation function list generated by the LLM 1614_1 using the agnostic checker 1614_2, and/or to at least partly fill a plan query.

According to an embodiment of the disclosure, the memory 1614 may store one or more instructions or program codes for executing the second sub-module 1614_3. The second sub-module 1614_3 may be related to the second external electronic device 1630. For example, the second sub-module 1614_3 may execute one or more functions for controlling an operation of the second external electronic device 1630. The second sub-module 1614_3 may operate and be implemented in a similar manner to a sub-module (e.g., the first sub-module 120, the second sub-module 130, and the sub-module 1300) described with reference to FIGS. 1 to 15. For example, the memory 1614 may store one or more instructions and/or program codes for causing the electronic device 1610 to perform one or more operations for controlling the second external electronic device 1630 by using the second sub-module 1614_3 according to the plan query generated by the LLM 1614_1, and to obtain values corresponding to one or more blank queries.

According to an embodiment of the disclosure, the memory 1614 may store one or more instructions or program codes for executing the third sub-module 1614_4. The third sub-module 1614_4 may be related to the application 1614_5 loaded to the memory 1614. For example, the third sub-module 1614_4 may execute one or more functions for controlling an operation of the application 1614_5. The third sub-module 1614_4 may operate and be implemented in a similar manner to the sub-module (e.g., the first sub-module 120, the second sub-module 130, and the sub-module 1300) described with reference to FIGS. 1 to 15. For example, the memory 1614 may store one or more instructions and/or program codes for causing the electronic device 1610 to perform one or more operations for controlling the application 1614_5 by using the third sub-module 1614_4 according to the plan query generated by the LLM 1614_1, and to obtain values corresponding to one or more blank queries.

According to an embodiment of the disclosure, the memory 1614 may store one or more instructions or program codes for executing the application 1614_5. The processor 1612 may execute the application 1614_5 loaded to the memory 1614. Operations of the application 1614_5 may be controlled by the third sub-module 1614_4. For example, the third sub-module 1614_4 may execute one or more functions for controlling the operations of the application 1614_5. The third sub-module 1614_4 may obtain one or more values from the application 1614_5.

The communication interface 1616 may perform, under the control by the processor 1612, data communication with an external device (e.g., the first external electronic device 1620, the second external electronic device 1630, or the user terminal 1640). For example, the communication interface 1616 may receive an input query from the external device (e.g., the user terminal 1640), and may transmit a final response to the input query to the external device. In an embodiment of the disclosure, the communication interface 1616 may include communication circuitry (various types of communication circuitry) configured to perform data communication between the electronic device 1610 and other electronic devices by using at least one of data communication schemes including wired LAN, wireless LAN, Wi-Fi, Bluetooth, ZigBee, WFD, IrDA, BLE, NFC, WiBro, WiMAX, SWAP, WiGig, and RF communication.

The electronic device 1610 may communicate with the first external electronic device 1620 by using the communication interface 1616. The first external electronic device 1620 may include a first sub-module 1622. The first sub-module 1622 may operate and be implemented in a similar manner to the sub-module (e.g., the first sub-module 120, the second sub-module 130, and the sub-module 1300) described with reference to FIGS. 1 to 15. For example, the first sub-module 1622 may receive, from the electronic device 1610, the blank query, the guide query, and/or the expectation function list, which is generated by the LLM 1614_1. The first sub-module 1622 may perform one or more operations for controlling the first external electronic device 1620 according to the blank query, the guide query, and/or the expectation function list. The first sub-module 1622 may obtain one or more values corresponding to one or more blank queries. The first sub-module 1622 may generate a response to be returned to the LLM 1614_1, based on the obtained one or more values. The first sub-module 1622 may transmit the generated response to the electronic device 1610. The electronic device 1610 may receive the response from the first sub-module 1622 by using the communication interface 1616, and may provide the received response to the LLM 1614_1.

The electronic device 1610 may communicate with the second external electronic device 1630 by using the communication interface 1616. The second external electronic device 1630 may be controlled by the second sub-module 1614_3. For example, the second sub-module 1614_3 may generate one or more control signals, control commands, or control instructions for controlling the second external electronic device 1630. The one or more control signals, the control commands, or the control instructions generated by the second sub-module 1614_3 may be provided to the second external electronic device 1630 via the communication interface 1616. The second external electronic device 1630 may perform one or more operations according to the one or more control signals, the control commands, or the control instructions, and may return a result thereof to the second sub-module 1614_3. The electronic device 1610 may receive the result from the second external electronic device 1630 by using the communication interface 1616, and may provide the received result to the second sub-module 1614_3.

The electronic device 1610 may communicate with the user terminal 1640 by using the communication interface 1616. The user terminal 1640 may directly obtain an input query from a user, and may transmit the obtained input query to the electronic device 1610. The electronic device 1610 may receive the input query from the user terminal 1640 by using the communication interface 1616. The electronic device 1610 may obtain a final response based on the input query, by using the LLM 1614_1. The electronic device 1610 may transmit the final response to the user terminal 1640 by using the communication interface 1616.

According to an embodiment of the disclosure, the electronic device 1610 may additionally include a user interface for directly obtaining an input query from a user and for directly returning a final response to the user. For example, the electronic device 1610 may additionally include at least one of various input devices including a keyboard, a mouse, a microphone, or a touch screen. The electronic device 1610 may additionally include at least one of various output devices including a represent device or a speaker.

According to an embodiment of the disclosure, the LLM-based system 1600 may control various devices (e.g., the first external electronic device 1620 and the second external electronic device 1630) or a plurality of items of software (e.g., the application 1614_5) according to an input query by using the LLM 1614_1 and the first to third sub-modules 1622, 1614_3, and 1614_4 each having sub-LM. A sub-module according to an embodiment of the disclosure may be positioned with the LLM 1614_1 in a server (e.g., the second sub-module 1614_3 and the third sub-module 1614_4)), or may be positioned in a device related to each sub-module (e.g., the first sub-module 1622).

According to an embodiment of the disclosure, the LLM-based system 1600 may include the electronic device 1610 storing the LLM 1614_1, and the first external electronic device 1620 configured to communicate with the electronic device 1610 and including the first sub-module 1622. The electronic device 1610 may be configured to obtain an input query. The electronic device 1610 may be configured to generate a plan query, etc.) including one or more blank queries (e.g., first blank query, second blank query, etc.) to be filled with values related to the first sub-module 1622 including a first sub-LM and one or more operations to be performed by the first sub-module 1622, based on an input query. The electronic device 1610 may be configured to transmit, to the first sub-module 1622, a request for returning one or more values corresponding to the one or more blank queries and at least a part of the plan query with a first guide query at least partly based on a part of the input query which is related to the sub-module. The electronic device 1610 may be configured to receive, from the first sub-module 1622, a first response generated by using the first sub-LM and including one or more values. The electronic device 1610 may be configured to generate, by using the LLM 1614_1, a final response to the input query, based on the first response.

Additionally or alternatively, the first sub-module 1622 may include a retrieving module configured to retrieve one or more functions for controlling the first external electronic device 1620, and an execution module configured to execute one or more functions retrieved by the retrieving module and obtain one or more values. The first sub-LM of the first sub-module 1622 may be configured to rewrite the first guide query for retrieving one or more functions by using the retrieving module. The first sub-LM may be configured to generate the first response, based on one or more values obtained by the execution module.

Additionally or alternatively, the system 1600 may include the second external electronic device 1630 configured to communicate with the electronic device 1610. The electronic device 1610 may include the second sub-module 1614_3 including a second sub-LM. The plan query may additionally include one or more blank queries to be filled with values related to a second sub-module 1632 and one or more operations to be performed by the second sub-module 1632. The second sub-module 1632 may be configured to retrieve one or more functions for controlling the second external electronic device 1630, based on at least a part of the plan query. The second sub-module 1632 may execute retrieved one or more functions for controlling the second external electronic device 1630. The second sub-module 1632 may obtain one or more values corresponding to one or more blank queries to be filled with values related to the second sub-module 1632. The second sub-module 1632 may generate, by using the second sub-LM, a second response including the one or more values corresponding to the one or more blank queries to be filled with the values related to the second sub-module 1632. The second sub-module 1632 may be configured to provide the second response to the LLM 1614_1.

According to an embodiment of the disclosure, the aforementioned one or more operations and/or features of an LLM (e.g., the LLM 110), and the aforementioned one or more operations and/or features of a sub-LM (e.g., the first sub-LM 122) may be combined to one LLM. For example, a single LLM may establish a plan query including one or more blank queries. The single LLM may generate a guide query for a sub-module based on an input query. The single LLM may rewrite a module-oriented query for a sub-module. The single LLM may execute a function and may request the sub-module to return one or more values corresponding to one or more blank queries. The single LLM may generate a final response by using one or more values returned from the sub-module.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to an embodiment, the method according to various embodiments of the present document may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user apparatuses (e.g., smartphones). In a case of online distribution, at least a portion of the computer program product (e.g., a downloadable application) may be at least temporarily stored or temporarily generated in a machine-readable storage medium such as a manufacturer's server, a server of an application store, or memory of a relay server.

Although example embodiments of the disclosure have been described and shown, various modifications and changes may be made by one of skill in the art from the above description. For example, suitable results may be obtained even when the described techniques are performed in a different order and/or when components such as the described computer system or modules are coupled or combined in a different manner, or replaced or supplemented by other components or their equivalents.

What is claimed is:

1. A method for query generation and query response generation, the method being executed by at least one processor of an electronic device collectively or individually, the method comprising:
obtaining an input query;
generating, by using a large language model (LLM), based on the input query, a plan query comprising one or more blank queries related to a first sub-module and one or more operations to be performed by the first sub-module, the first sub-module comprising a sub-language model (LM);
transmitting, to the first sub-module, (a) a request for generating a first response comprising one or more values corresponding to the one or more blank queries, (b) at least a part of the plan query, and (c) a first guide query, the first guide query being based on a part of the input query associated with the first sub-module;
receiving, from the first sub-module, the first response generated by using the sub-LM of the first sub-module, the first response comprising the one or more values; and
generating, by using the LLM, a final response to the input query, based on the first response.

2. The method of claim 1, wherein a first blank query among the one or more blank queries corresponds to at least one of an actual value to be obtained from the first sub-module, a value dependent on a state of the first sub-module, a value dependent on an attribute of the first sub-module, a value indicating a result of any one of the one or more operations, or a condition indicated by the input query.

3. The method of claim 1, wherein the generating the plan query by using the LLM comprises:
inputting the input query into the LLM;
obtaining, based on the LLM, the plan query comprising the one or more operations, an order of the one or more operations, and the one or more blank queries; and
obtaining, based on the LLM, the first guide query which is based on the part of the input query being related to the first sub-module, and indicates the one or more operations.

4. The method of claim 1, wherein the transmitting the request, the at least a part of the plan query, and the first guide query comprises:
obtaining a list of one or more functions to be performed by the first sub-module, based on the input query;
modifying, by an agnostic checker, the list of the one or more functions, based on at least a part of function update information indicating functions currently supported by the first sub-module and a deprecated version handling policy comprising a handling policy of one or more functions that are deprecated; and
transmitting the modified list of the one or more functions to the first sub-module.

5. The method of claim 4, wherein the modifying the list of the one or more functions comprises:
identifying, based on the part of function update information, whether the one or more functions comprised in the list are currently supported by the first sub-module; and
based on identifying that a first function among the one or more functions comprised in the list is not currently supported by the first sub-module, converting, based on the deprecated version handling policy, at least some functions comprising the first function among the one or more functions to one or more functions that are currently supported by the first sub-module.

6. The method of claim 4, wherein the modifying the list of the one or more functions comprises:
identifying, based on the part of function update information, whether the one or more functions comprised in the list are currently supported by the first sub-module; and
based on identifying that a second function among the one or more functions comprised in the list is not currently supported by the first sub-module, removing the second function from the list of the one or more functions.

7. The method of claim 4, wherein the transmitting the request, the at least a part of the plan query, and the first guide query comprises:
modifying, by the agnostic checker, the plan query, based on a value corresponding to one of the one or more blank queries, the value being previously stored in the agnostic checker; and
transmitting, to the first sub-module, the modified plan query.

8. The method of claim 1, wherein the generating the final response to the input query comprises:
inputting the first response to the LLM; and
obtaining, based on the LLM, the final response to the input query, based on the one or more values corresponding to the one or more blank queries comprised in the first response.

9. The method of claim 1, wherein the generating of the final response to the input query comprises:
inputting the first response to the LLM;
identifying that the first response does not include a value corresponding to a second blank query included in the plan query;
obtaining, based on the LLM, (a) an additional plan query comprising the second blank query and (b) an additional guide query;
transmitting, to a second sub-module, (a) a request for generating an additional response comprising the value corresponding to the second blank query, (b) the additional plan query, and (c) the additional guide query;
receiving, from the second sub-module, the additional response comprising the value corresponding to the second blank query; and
obtaining the final response based on the additional response by using the LLM.

10. The method of claim 1, wherein the plan query further comprises a first operation to be performed by the first sub-module, the first operation being indicated by the input query, and a third blank query associated with a third value indicating whether a precedent condition of the first operation is satisfied.

11. The method of claim 10, wherein the transmitting the request, the at least a part of the plan query, and the first guide query comprises:
transmitting, to the first sub-module, the first guide query with a request for generating the first response comprising the third value corresponding to the third blank query;
identifying a waiting for performance of the first operation; and
based on identifying the waiting for performance of the first operation, generating, by using the LLM, a first subsequent plan query for which the precedent condition of the first operation is satisfied, and a second subsequent plan query for which the precedent condition of the first operation is not satisfied, and
wherein the first subsequent plan query and the second subsequent plan query comprise the third blank query.

12. The method of claim 11, wherein the first response comprises the third value, and
the generating of the final response to the input query comprises:
selecting one subsequent plan query among the first subsequent plan query and the second subsequent plan query, based on the third value; and
generating the final response, based on the selected subsequent plan query and the third value.

13. The method of claim 11, wherein the first response comprises a value indicating a failure of the first operation, and
the generating of the final response to the input query comprises:
based on the value indicating the failure of the first operation, discarding the first subsequent plan query and the second subsequent plan query; and
based on the value indicating the failure of the first operation, generating the final response based on information indicating the failure of the first operation.

14. The method of claim 1, wherein the generating the plan query comprises:
transmitting, to the sub-LM, an inquiry as to whether a second operation among the one or more operations is supported by the first sub-module;
receiving, from the sub-LM, a second response indicating that the second operation is supported by the first sub-module; and
based on the second response, generating the plan query comprising the second operation to be performed by the first sub-module.

15. A non-transitory computer-readable storage medium storing instructions, that when executed by at least one processor, collectively or individually, cause the at least one processor to:
obtain an input query;
generate, by using a large language model (LLM), based on the input query, a plan query comprising one or more blank queries related to a first sub-module and one or more operations to be performed by the first sub-module, the first sub-module comprising a sub-language model (LM);
transmit, to the first sub-module, (a) a request for generating a first response comprising one or more values corresponding to the one or more blank queries, (b) at least a part of the plan query, and (c) a first guide query, the first guide query being based on a part of the input query associated with the first sub-module;
receive, from the first sub-module, the first response generated by using the sub-LM of the first sub-module, the first response comprising the one or more values; and
generate, by using the LLM, a final response to the input query, based on the first response.

16. An electronic device comprising:
at least one processor comprising processing circuitry; and
memory comprising one or more storage media and storing one or more instructions,
wherein the one or more instructions, when executed by the at least one processor individually or collectively, cause the electronic device to:
obtain an input query;
generate, by using a large language model (LLM), based on the input query, a plan query comprising one or more blank queries related to a first sub-module and one or more operations to be performed by the first sub-module, the first sub-module comprising a sub-language model (LM);
transmit, to the first sub-module, (a) a request for generating a first response comprising one or more values corresponding to the one or more blank queries, (b) at least a part of the plan query, and (c) a first guide query, the first guide query being based on a part of the input query associated with the first sub-module;
receive, from the first sub-module, the first response generated by using the sub-LM of the first sub-module, the first response comprising the one or more values; and
generate, by using the LLM, a final response to the input query, based on the first response.

17. The electronic device of claim 16, wherein a first blank query among the one or more blank queries corresponds to at least one of an actual value to be obtained from the first sub-module, a value dependent on a state of the first sub-module, a value dependent on an attribute of the first sub-module, a value indicating a result of any one of the one or more operations, or a condition indicated by the input query.

18. The electronic device of claim 16, wherein the one or more instructions, when executed by the at least one processor individually or collectively, further cause the electronic device to:
obtain a list of one or more functions to be performed by the first sub-module, based on the input query;
modify, by an agnostic checker, the list of the one or more functions, based on at least a part of function update information indicating functions currently supported by the first sub-module and a deprecated version handling policy comprising a handling policy of one or more functions that are deprecated; and
transmit the modified list of the one or more functions to the first sub-module.

19. The electronic device of claim 18, wherein the one or more instructions, when executed by the at least one processor individually or collectively, additionally cause the electronic device to:
modify, by the agnostic checker, the plan query, based on a value corresponding to one of the one or more blank queries, the value being previously stored in the agnostic checker; and
transmit, to the first sub-module, the modified plan query.

20. The electronic device of claim 1, wherein the plan query comprises a first operation to be performed by the first sub-module, the first operation being indicated by the input query, and a third blank query associated with a third value indicating whether a precedent condition of the first operation is satisfied, and
wherein the one or more instructions, when executed by the at least one processor individually or collectively, further cause the electronic device to:
transmit, to the first sub-module, the first guide query with a request for generating the first response comprising the third value corresponding to the third blank query;
identify a waiting for performance of the first operation; and
based on identifying the waiting for performance of the first operation, generate, by using the LLM, a first subsequent plan query for which the precedent condition of the first operation is satisfied, and a second subsequent plan query for which the precedent condition of the first operation is not satisfied,
wherein the first subsequent plan query and the second subsequent plan query comprise the third blank query.
